(19) United States
(12) Patent Application Publication
(10) Pub. No.: US 2005/0225644 A1
(43) Pub. Date: Oct. 13, 2005

(54) Digital camera, album managing method, album management program product, and album management program transmission medium

(75) Inventors: Kazuyuki Shibuya, Sagamihara (JP); Shinya Kawasaki, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 11/095,992

(22) Filed: Mar. 31, 2005

(30) Foreign Application Priority Data
Apr. 7, 2004 (JP) 2004-113301

(51) Int. Cl. H04N 5/225

(52) U.S. Cl. 348/207.99

(57) ABSTRACT

A digital camera includes: a device for obtaining the number of registered images of the album which is the number of image configuring an album based on a control file for management of a taken image; and a device for obtaining the number of remaining images to be registered in the album which is the number of remaining images which can be registered in the album based on the control file and a predetermined maximum number of registered images capable of configuring the album to display an arbitrary image forming part of the album, and switch and display the obtained number of registered images of the album, thereby displaying images configuring an electronic album, and displaying information about the electronic album such as information about the number of image data files in an album, information about when an image in the album was taken, etc.

### CROSS REFERENCE TO RELATED APPLICATIONS

This application claims benefit of Japanese Applications No. 2004-113301, filed Apr. 7, 2004, the contents of which are incorporated by this reference.

### BACKGROUND OF THE INVENTION

1. Field of the Invention

The present invention relates to a digital camera having an album facility, and an album management program product, an album management program product, and an album management program transmission medium for an electronic album by the digital camera, and more specifically to a digital camera, an album managing method, an album management program product, and an album management program transmission medium for displaying the information about the electronic album.

2. Description of the Related Art

There has conventionally been album software for managing a large amount of images taken by a digital still camera (hereinafter referred to simply as a “camera”) by classifying them depending on the shooting date, the shooting place, the events such as an athletic meeting, a trip, etc. Since album software has been used by being executed by a PC mounted in a user home, etc., the facility provided by the album software, for example, the facility of generating an album, adding and deleting an image to and from the album, replacing an image for another album, browsing an album, etc. has only been used in the user home. On the other hand, to answer the request of a user to browse an album during the trip without the PC, etc. a camera having an album facility has been marketed lately.

The method for managing image data using a camera having an album facility is explained below by referring to FIGS. 1A and 1B.

FIGS. 1A and 1B show the management structure of an image data file for a record medium such as a memory card, etc. for storing image data taken by a camera. FIG. 1A shows an example of management for multiple use of an image data file. FIG. 1B shows an example of management using an image list file.

In the folder structure shown in FIG. 1A, an image root folder DCIM and an album root folder ALBUM are arranged directly under a root directory ROOT.

The image root folder DCIM is a root folder for storing an image data file. Directly under the folder, a 100 OLYMP folder is stored as an image storage folder. In FIG. 1A, the 100 OLYMP folder stores an image data file for an image taken by a camera. That is, in FIG. 1A, an image data file such as 001. JPG, 002. JPG, 003. JPG, etc. is stored in the 100 OLYMP folder.

An album root folder ALBUM is a root folder for storing an image data file contained in an album. The folder stores an album folder such as an ALBUM1, an ALBUM2, etc. In FIG. 1A, among the albums, the album folder ALBUM1 stores image data files such as XXX. JPG, 003. JPG, YYY. JPG, . . . , etc. The folder structure shows that the images represented by these image data files belong to (are contained in) the album “ALBUM1”.

In FIG. 1A, the image data file 003.JPG pointed to by the arrow is stored in both the image root folder DCIM and the album root folder ALBUM. That is, since the record medium stores two image data files having the same data contents, the record area is wasted. In the camera, a waste of a record area invites a decrease in number of images to be taken, and it not desired. Additionally, the waste of a record area further increases when the same image data file belong to a plurality of albums.

In the folder structure shown in FIG. 1B, the image root folder DCIM and the album list file ALBUM.PVM are stored directly under the root folder ROOT.

As shown in FIG. 1A, the image root folder DCIM shown in FIG. 1B also is a root folder of an image data file, and directly below the root folder, a folder named 100 OLYMP folder is stored as an image storage folder. However, in FIG. 1B, the 100 OLYMP folder stores an image data file for the image taken by a camera, and also stores an image data file stored in an album. In FIG. 1B, an image data file such as 001. JPG, 002. JPG, 003. JPG, . . . , XXX. JPG, YYY. JPG, . . . , etc. is stored in the 100 OLYMP folder.

The album list file ALBUM.PVM is a relational information file indicating the relationship between the image data file stored in the image root folder DCIM and the album to which the image data file belongs (or containing the image data file). As shown in FIG. 1B, the album list file has the data structure in which the file name of the image data file belonging to each album is arranged for each album. The array of the file names of each album indicates the dependency between the image data file and the album. According to an example of data of ALBUM.PVM shown in FIG. 1B, for example, the image data file belonging to the album called “ALBUM1” can be XXX. JPG, 003. JPG, YYY. JPG, . . . , etc., and the relationship between the image data file and the album is shown as in FIG. 1A. In the example of the data of ALBUM.PVM shown in FIG. 1B, the information (100OLYMP) indicating the folder storing the image data file is omitted.

By adopting the method indicating the dependency between the image data file and the album using the album list file as shown in FIG. 1B, the problem of the waste of the record area that stores a plurality of the same image data files in a record medium can be solved. Therefore, the record medium of a camera which is subject to strict restrictions on a record capacity can be efficiently used.

The method of managing an album using an image list file is also proposed by the MPV (music photo video) standard developed by the OSTA (Optical Storage Technology Association) which is an organization for standardizing optical storage).

The above-mentioned album software or camera having an album facility can display the number of remaining images to be taken. Thus, for example, when the number of remaining images is small, another medium is prepared, an image of less importance is deleted, etc. Furthermore, the model name of a camera which has taken an image and the shooting mode are added to a file name, or the file name being regenerated is displayed. Thus, since the history of images (which camera has been used) can be obtained by a user, and the shooting mode can be obtained, a user can be helped in being informed how the number of remaining images increases by deleting which image if any image is to be deleted when the number of remaining images becomes smaller (for example, Japanese Published Patent Application No. 2000-92417).

### SUMMARY OF THE INVENTION

According to an aspect of the present invention, the digital camera of the present invention is a digital camera having a control file for managing a taken image, an album facility for generating and managing an album configured by one or more images based on the control file, and a display device for displaying an image, and includes a device for obtaining the number of registered images of the album for obtaining the number of registered images of the album which is the number of images configuring the album based on the control file, and a device for obtaining the number of remaining images to be registered in the album for obtaining the number of remaining images to be registered in the album which is the number of remaining images to be taken and registered in the album based on the maximum number of registered images capable of configuring the album which is predetermined, and the display device displays an arbitrary image configuring part of the album, and switches and displays the number of registered images of the album obtained by the device for obtaining the number of registered images of the album or the number of remaining images to be registered in the album obtained by the device for obtaining the number of remaining images to be registered in the album.

### BRIEF DESCRIPTION OF THE DRAWINGS

The present invention will be more apparent from the following detailed description when the accompanying drawings are referenced.

FIG. 1A is an explanatory view (1) of the method of managing image data in an camera with an album facility;

FIG. 1B is an explanatory view (2) of the method of managing image data in an camera with an album facility;

FIG. 2A is an explanatory view of the outline of an embodiment of an album facility;

FIG. 2B is a view (1) of the configuration of the hardware of the camera and the PC shown in FIG. 2A;

FIG. 2C is a view (2) of the configuration of the hardware of the camera and the PC shown in FIG. 2A;

FIG. 3 is a flowchart showing the contents of the taken image obtaining process;

FIG. 4 is a flowchart (1) showing the contents of the album manipulating process;

FIG. 5 is a flowchart (2) showing the contents of the album manipulating process;

FIG. 6 shows an example of an album manipulation screen;

FIG. 7 is a flowchart showing the contents of the cover image generating process;

FIG. 8 shows an example of a cover image generation screen;

FIG. 9 is a flowchart showing the contents of the title composing process;

FIG. 10 shows an example of a title input screen;

FIG. 11 is a flowchart showing the contents of the album transfer process;

FIG. 12 is a flowchart showing the contents of the album receiving process;

FIG. 13 is a flowchart showing the contents of the album regenerating process;

FIG. 14A is a view (1) showing an example of a display screen of the camera;

FIG. 14B is a view (2) showing an example of a display screen of the camera;

FIG. 14C is a view (3) showing an example of a display screen of the camera;

FIG. 15 is a flowchart showing the contents of the album selecting process;

FIG. 16 is a flowchart (1) showing the flow of the process of switching and displaying the number of registered images of the album and the number of remaining images to be registered in the album when cover images of a plurality of albums are to be listed;

FIG. 17 is a flowchart (2) showing the flow of the process of switching and displaying the number of registered images of the album and the number of remaining images to be registered in the album when cover images of a plurality of albums are to be listed;

FIG. 18 is a flowchart showing the flow of the “album information display contents switching process” performed in step S251 shown in FIG. 17;

FIG. 19 shows an example of switching an album information display contents;

FIG. 20 is a flowchart showing the flow of the “process of obtaining and displaying each album” performed in step S262 shown in FIG. 18;

FIG. 21 is a flowchart showing the flow of the “process of displaying the number of images in the album” performed in step S272 shown in FIG. 20;

FIG. 22 is a view showing an example of displaying together with a listing the number of registered images in the mode of displaying album information about all albums;

FIG. 23 is a view showing an example of displaying together with a listing the number of registered images in the mode of displaying album information about a part of albums;

FIG. 24 is a flowchart showing the flow of the “process of displaying the number of remaining images in the album” performed in step S273 shown in FIG. 20;

FIG. 25 is a view showing an example of displaying together with a listing the number of remaining images in the mode of displaying album information about all albums;

FIG. 26 is a view showing an example of displaying together with a listing the number of remaining images in the mode of displaying album information about a part of albums;

FIG. 27 is a flowchart showing the flow of the “generation date displaying process in the album” performed in step S274 shown in FIG. 20;

FIG. 28 is a view showing an example of displaying together with a listing the album generation date in the mode of displaying album information about all albums;

FIG. 29 is a view showing an example of displaying together with a listing the album generation date in the mode of displaying album information about a part of albums;

FIG. 30 is a flowchart showing the flow of the “process of displaying the shooting period in the album” performed in step S275 shown in FIG. 20;

FIG. 31A is an explanatory view (1) showing an example of displaying an album information description unit;

FIG. 31B is an explanatory view (2) showing an example of displaying an album information description unit;

FIG. 31C is an explanatory view (3) showing an example of displaying an album information description unit;

FIG. 32 is a flowchart showing the flow of the “process of displaying a folder in the album” performed in step S276 shown in FIG. 20;

FIG. 33 is a flowchart showing the flow of the “process of displaying the capacity in the album” performed in step S277 shown in FIG. 20;

FIG. 34 is a flowchart showing the flow of the “process of displaying the number of SHQ images in the album” performed in step S278 shown in FIG. 34;

FIG. 35 is a view showing an example of displaying together with a listing the number of SHQ images in the album in the mode of displaying album information about all albums;

FIG. 36 is a flowchart showing the flow of the “process of displaying the quality of images in the album” performed in step S281 shown in FIG. 20;

FIG. 37 is a view showing an example of displaying together with a listing the all information in the album in the mode of displaying album information about a part of albums;

FIG. 38 is a view showing an example of sorting and displaying album information;

FIG. 39 is a flowchart (1) showing the flow of the process of displaying the number of images registered in each album and the album generation date of a selected album when the cover images of a plurality of albums are to be listed;

FIG. 40 is a flowchart (2) showing the flow of the process of displaying the number of images registered in each album and the album generation date of a selected album when the cover images of a plurality of albums are to be listed;

FIG. 41 shows an example of displaying together with a listing the number of images registered in each album and the album generation date of a selected album;

FIG. 42 is a flowchart showing the flow of the process of displaying the number of images registered in each album and the shooting period for a selected album when the cover images of a plurality of albums are to be listed;

FIG. 43 shows an example of displaying together with a listing the number of images registered in each album and the album shooting period for a selected album;

FIG. 44 is a flowchart showing the flow of the process of displaying the album information about a selected album when the cover images of a plurality of albums are listed;

FIG. 45 is a view showing an example of displaying together with a listing the album information about an album;

FIG. 46 is a flowchart showing the flow of the process of displaying the number of images registered in each album when an image registered in a specific album;

FIG. 47 shows an example of displaying together with a listing of images registered in a specific album the number of images registered in all albums; and

FIG. 48 shows an example of displaying together with an image registered in a specific album the number of images registered in all albums.

### DESCRIPTION OF THE PREFERRED EMBODIMENTS

The embodiments of the present invention are described below by referring to the attached drawings.

That is, according to an aspect of the present invention, the digital camera of the present invention is a digital camera having a control file for managing a taken image, an album facility for generating and managing an album configured by one or more images based on the control file, and a display device for displaying an image, and includes a device for obtaining the number of registered images of the album for obtaining the number of registered images of the album which is the number of images configuring the album based on the control file, and a device for obtaining the number of remaining images to be registered in the album for obtaining the number of remaining images to be registered in the album which is the number of remaining images to be taken and registered in the album based on the maximum number of registered images capable of configuring the album which is predetermined, and the display device displays an arbitrary image configuring part of the album, and switches and displays the number of registered images of the album obtained by the device for obtaining the number of registered images of the album or the number of remaining images to be registered in the album obtained by the device for obtaining the number of remaining images to be registered in the album.

It is desired that, in the digital camera according to the present invention, the device for obtaining the number of registered images of the album obtains the number of registered images of an album for a plurality of albums, the device for obtaining the number of remaining images to be registered in the album obtains the number of remaining images to be registered in an album for a plurality of albums, and the display device displays the registered images of a selected album or the number of remaining images to be registered in the album, and displays the registered images of an unselected album or the number of remaining images to be registered in the album in different formats.

It is also desired that, the digital camera according to the present invention further comprises a shooting date obtaining device for obtaining the shooting date of an arbitrary image configuring the album based on the control file, and the display device switches and displays the number of registered images of the album, the number of remaining images to be registered in the album, or the shooting periods of all images configuring the album obtained based on the shooting dates of all images configuring the album obtained by the shooting date obtaining device.

It is further desired that, in the digital camera according to the present invention, the display device switches and displays the number of registered images of the album, the number of remaining images to be registered in the album, the shooting period, or an album generation date indicating the day on which the album obtained based on the control file was generated.

It is also desired that the digital camera according to the present invention further comprises based on the control file an image information obtaining device for obtaining the image capacity indicating the capacity of all images configuring the album, the image quality indicating the quality of an image configuring the album, and the image type information about the type of the image configuring part of the album, and the display device switches and displays the number of registered images of the album, the number of remaining images to be registered in the album, the shooting period, or the album generation date, and the image capacity, the image quality, or the image type information obtained by the image information obtaining device.

It is further desired that, in the digital camera according to the present invention, the display device displays the number of registered images of a selected album, the number of remaining images to be registered in the album, the shooting period, the album generation date, the image capacity, and the image quality, or displays together with the display of the image type information the number of registered images of an album near the selected album among unselected albums, the number of remaining images to be registered in the album, the shooting period, the album generation date, the image capacity, the image quality, or the image type information.

It is also desired that, in the digital camera according to the present invention, the display device displays the number of registered images of the album, the number of remaining images to be registered in the album, the shooting period, the album generation date, the image capacity, the image quality, or the image type information in an ascending or descending order.

According to an aspect of the present invention, the digital camera of the present invention is a digital camera having a control file for managing a taken image, an album facility for generating and managing an album configured by one or more images based on the control file, and a display device for displaying an image, and includes a device for obtaining the number of registered images of the album for obtaining the number of registered images of the album which is the number of images configuring the album based on the control file, and a device for obtaining the number of remaining images to be registered in the album for obtaining the number of remaining images to be registered in the album which is the number of remaining images to be taken and registered in the album based on the maximum number of registered images capable of configuring the album which is predetermined, and the display device displays an arbitrary image configuring part of the album, displays the number of registered images of the album obtained by the device for obtaining the number of registered images of the album, and displays the number of remaining images to be registered in the album obtained by the device for obtaining the number of remaining images to be registered in the album for a selected album.

It is also desired that, in the digital camera according to the present invention, the display device displays the registered images of a selected album and the number of remaining images to be registered in the album in a format different from the registered images of unselected albums.

Additionally, according to an aspect of the present invention, the album managing method of the present invention is used by a digital camera having a control file for managing a taken image, an album facility for generating and managing an album configured by one or more images based on the control file, and a display device for displaying an image, and includes: obtaining the number of registered images of the album for obtaining the number of registered images of the album which is the number of images configuring the album based on the control file, obtaining the number of remaining images to be registered in the album for obtaining the number of remaining images to be registered in the album which is the number of remaining images to be taken and registered in the album based on the maximum number of registered images capable of configuring the album which is predetermined, display by the display device displaying an arbitrary image configuring part of the album, and switching and displaying the number of registered images of the obtained album or the number of remaining images to be registered in the obtained album.

It is desired that, in the album managing method according to the present invention, obtaining the number of registered images of the album obtains the number of registered images of an album for a plurality of albums, obtaining the number of remaining images to be registered in the album obtains the number of remaining images to be registered in an album for a plurality of albums, and display by the display device displays the registered images of a selected album or the number of remaining images to be registered in the album, and displays the registered images of an unselected album or the number of remaining images to be registered in the album in different formats.

It is also desired that, the album managing method according to the present invention further comprises: obtaining the shooting date of an arbitrary image configuring the album based on the control file, and display by the display device switching and displaying the number of registered images of the album, the number of remaining images to be registered in the album, or the shooting periods of all images configuring the album obtained based on the shooting dates of all images configuring the album obtained by the shooting date obtaining device.

It is further desired that, in the album managing method according to the present invention, the display by the display device switches and displays the number of registered images of the album, the number of remaining images to be registered in the album, the shooting period, or an album generation date indicating the day on which the album obtained based on the control file was generated.

It is also desired that the album managing method according to the present invention obtains based on the control file the image capacity indicating the capacity of all images configuring the album, the image quality indicating the quality of an image configuring the album, and the image type information about the type of the image configuring part of the album, and display by the display device switches and displays the number of registered images of the album, the number of remaining images to be registered in the album, the shooting period, or the album generation date, and the obtained image capacity, the image quality, or the image type information.

It is further desired that, in the album managing method according to the present invention, display by the display device displays the number of registered images of a selected album, the number of remaining images to be registered in the album, the shooting period, the album generation date, the image capacity, and the image quality, or displays together with the display of the image type information the number of registered images of an album near the selected album among unselected albums, the number of remaining images to be registered in the album, the shooting period, the album generation date, the image capacity, the image quality, or the image type information.

It is also desired that, in the album managing method according to the present invention, display by the display device displays the number of registered images of the album, the number of remaining images to be registered in the album, the shooting period, the album generation date, the image capacity, the image quality, or the image type information in an ascending or descending order.

Additionally, according to an aspect of the present invention, it is desired that the album managing method of the present invention is used by a digital camera having a control file for managing a taken image, an album facility for generating and managing an album configured by one or more images based on the control file, and a display device for displaying an image, and includes: obtaining the number of registered images of the album for obtaining the number of registered images of the album which is the number of images configuring the album based on the control file, obtaining the number of remaining images to be registered in the album for obtaining the number of remaining images to be registered in the album which is the number of remaining images to be taken and registered in the album based on the maximum number of registered images capable of configuring the album which is predetermined, display by the display device displaying an arbitrary image configuring part of the album, displaying the number of registered images of the obtained album and the number of remaining images to be registered in the obtained album for a selected album.

It is also desired that, in the album managing method according to the present invention, display by the display device displays the registered images of a selected album and the number of remaining images to be registered in the album in a format different from the registered images of unselected albums.

Additionally, according to an aspect of the present invention, the album management program product of the present invention allows a digital camera having a control file for managing a taken image, an album facility for generating and managing an album configured by one or more images based on the control file, and a display device for displaying an image to perform the procedures of: obtaining the number of registered images of the album for obtaining the number of registered images of the album which is the number of images configuring the album based on the control file, obtaining the number of remaining images to be registered in the album for obtaining the number of remaining images to be registered in the album which is the number of remaining images to be taken and registered in the album based on the maximum number of registered images capable of configuring the album which is predetermined, display by the display device displaying an arbitrary image configuring part of the album, and switching and displaying the number of registered images of the obtained album or the number of remaining images to be registered in the obtained album.

It is desired that, in the album management program product according to the present invention, the procedure of obtaining the number of registered images of the album obtains the number of registered images of an album for a plurality of albums, the procedure of obtaining the number of remaining images to be registered in the album obtains the number of remaining images to be registered in an album for a plurality of albums, and the procedure of the display by the display device displays the registered images of a selected album or the number of remaining images to be registered in the album, and displays the registered images of an unselected album or the number of remaining images to be registered in the album in different formats.

It is also desired that, the album management program product according to the present invention further comprises the procedure of obtaining the shooting date of an arbitrary image configuring the album based on the control file, and the procedure of the display by the display device switching and displaying the number of registered images of the album, the number of remaining images to be registered in the album, or the shooting periods of all images configuring the album obtained based on the shooting dates of all images configuring the album obtained by the shooting date obtaining device.

It is further desired that, in the album management program product according to the present invention, the procedure of the display by the display device switches and displays the number of registered images of the album, the number of remaining images to be registered in the album, the shooting period, or an album generation date indicating the day on which the album obtained based on the control file was generated.

It is also desired that the album management program product according to the present invention further comprises the procedure of obtaining based on the control file the image capacity indicating the capacity of all images configuring the album, the image quality indicating the quality of an image configuring the album, and the image type information about the type of the image configuring part of the album, and the procedure of the display by the display device switches and displays the number of registered images of the album, the number of remaining images to be registered in the album, the shooting period, or the album generation date, and the obtained image capacity, the image quality, or the image type information.

It is further desired that, in the album management program product according to the present invention, the procedure of the display by the display device displays the number of registered images of a selected album, the number of remaining images to be registered in the album, the shooting period, the album generation date, the image capacity, and the image quality, or displays together with the display of the image type information the number of registered images of an album near the selected album among unselected albums, the number of remaining images to be registered in the album, the shooting period, the album generation date, the image capacity, the image quality, or the image type information.

It is also desired that, in the album management program product according to the present invention, the procedure of the display by the display device displays the number of registered images of the album, the number of remaining images to be registered in the album, the shooting period, the album generation date, the image capacity, the image quality, or the image type information in an ascending or descending order.

Additionally, according to an aspect of the present invention, it is desired that the album management program product of the present invention allows a digital camera having a control file for managing a taken image, an album facility for generating and managing an album configured by one or more images based on the control file, and a display device for displaying an image to perform the procedures of: obtaining the number of registered images of the album for obtaining the number of registered images of the album which is the number of images configuring the album based on the control file, obtaining the number of remaining images to be registered in the album for obtaining the number of remaining images to be registered in the album which is the number of remaining images to be taken and registered in the album based on the maximum number of registered images capable of configuring the album which is predetermined, display by the display device displaying an arbitrary image configuring part of the album, and displaying the number of registered images of the obtained album and the number of remaining images to be registered in the obtained album for a selected album.

It is also desired that, in the album management program product according to the present invention, the procedure of the display by the display device displays the registered images of a selected album and the number of remaining images to be registered in the album in a format different from the registered images of unselected albums.

Additionally, according to an aspect of the present invention, the album management program transmission medium of the present invention allows a digital camera having a control file for managing a taken image, an album facility for generating and managing an album configured by one or more images based on the control file, and a display device for displaying an image to perform the procedures of: obtaining the number of registered images of the album for obtaining the number of registered images of the album which is the number of images configuring the album based on the control file, obtaining the number of remaining images to be registered in the album for obtaining the number of remaining images to be registered in the album which is the number of remaining images to be taken and registered in the album based on the maximum number of registered images capable of configuring the album which is predetermined, display by the display device displaying an arbitrary image configuring part of the album, and switching and displaying the number of registered images of the obtained album or the number of remaining images to be registered in the obtained album.

It is also desired that, in the album management program transmission medium according to the present invention, the procedure of obtaining the number of registered images of the album obtains the number of registered images of an album for a plurality of albums, the procedure of obtaining the number of remaining images to be registered in the album obtains the number of remaining images to be registered in an album for a plurality of albums, and the procedure of the display by the display device displays the registered images of a selected album or the number of remaining images to be registered in the album, and displays the registered images of an unselected album or the number of remaining images to be registered in the album in different formats.

It is desired that the album management program transmission medium further comprises the procedure of obtaining the shooting date of an arbitrary image configuring the album based on the control file, and the procedure of the display by the display device switching and displaying the number of registered images of the album, the number of remaining images to be registered in the album, or the shooting periods of all images configuring the album obtained based on the shooting dates of all images configuring the album obtained by the shooting date obtaining device.

It is further desired that, in the album management program transmission medium according to the present invention, the procedure of the display by the display device switches and displays the number of registered images of the album, the number of remaining images to be registered in the album, the shooting period, or an album generation date indicating the day on which the album obtained based on the control file was generated.

It is also desired that the album management program transmission medium according to the present invention further comprises the procedure of obtaining based on the control file the image capacity indicating the capacity of all images configuring the album, the image quality indicating the quality of an image configuring the album, and the image type information about the type of the image configuring part of the album, and the procedure of the display by the display device switches and displays the number of registered images of the album, the number of remaining images to be registered in the album, the shooting period, or the album generation date, and the obtained image capacity, the image quality, or the image type information.

It is further desired that, in the album management program transmission medium according to the present invention, the procedure of the display by the display device displays the number of registered images of a selected album, the number of remaining images to be registered in the album, the shooting period, the album generation date, the image capacity, and the image quality, or displays together with the display of the image type information the number of registered images of an album near the selected album among unselected albums, the number of remaining images to be registered in the album, the shooting period, the album generation date, the image capacity, the image quality, or the image type information.

It is also desired that, in the album management program transmission medium according to the present invention, the procedure of the display by the display device displays the number of registered images of the album, the number of remaining images to be registered in the album, the shooting period, the album generation date, the image capacity, the image quality, or the image type information in an ascending or descending order.

Additionally, according to an aspect of the present invention, it is desired that the album management program transmission medium of the present invention allows a digital camera having a control file for managing a taken image, an album facility for generating and managing an album configured by one or more images based on the control file, and a display device for displaying an image to perform the procedures of: obtaining the number of registered images of the album for obtaining the number of registered images of the album which is the number of images configuring the album based on the control file, obtaining the number of remaining images to be registered in the album for obtaining the number of remaining images to be registered in the album which is the number of remaining images to be taken and registered in the album based on the maximum number of registered images capable of configuring the album which is predetermined, display by the display device displaying an arbitrary image configuring part of the album, and displaying the number of registered images of the obtained album and the number of remaining images to be registered in the obtained album for a selected album.

It is also desired that, in the album management program transmission medium according to the present invention, the procedure of the display by the display device displays the registered images of a selected album and the number of remaining images to be registered in the album in a format different from the registered images of unselected albums.

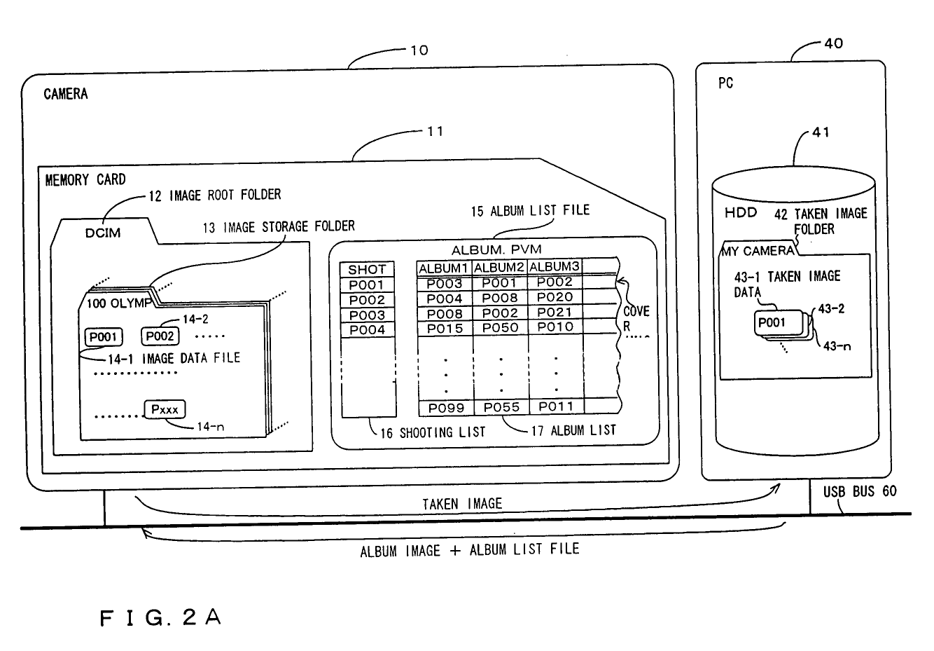

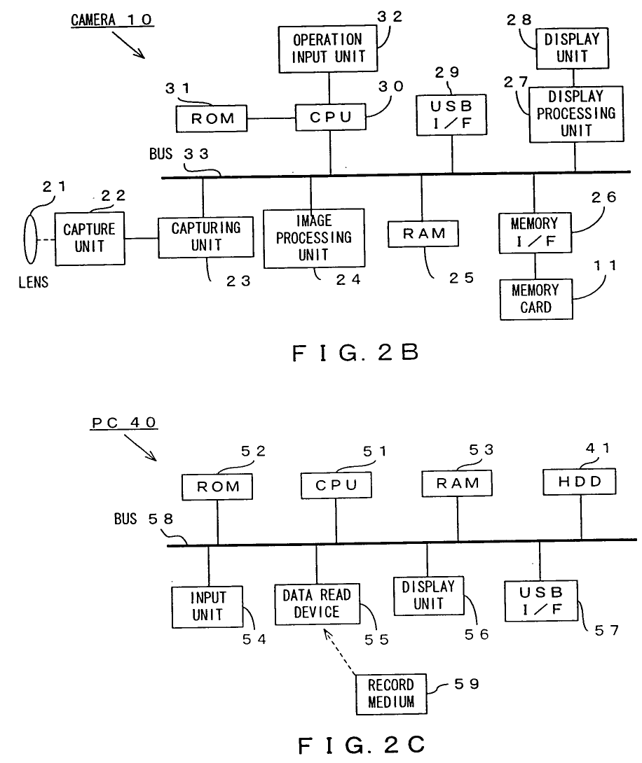

The outline of the album facility which is an embodiment of the present invention is explained below by referring to FIG. 2A.

FIG. 2A shows the outline of the embodiment of an album facility.

In FIG. 2A, a camera 10 and a PC 40 are connected via a USB (universal serial bus) bus 60, and can communicate various data with each other. In the present embodiment, an image taken by the camera 10 is temporarily transferred to the PC 40, the PC 40 generates an album for the image and transfers the generated album from the PC 40 to the camera 10. Therefore, when the user carries the camera 10, the PC 40 can browse the album.

FIG. 2A is further explained below. A removable memory card 11 is attached to the camera 10 so that various data can be recorded on the memory card 11. The memory card 11 stores an image root folder 12 and an album list file 15. They are arranged directly below the root directory in the record area of the memory card 11.

The images taken substantially at the same time by the camera 10 are stored in an image storage folder (“100 OLYMP” folder) 13 in the image root folder (“DCIM” folder) 12 as image data files 14-1, 14-2, . . . , 14-n, (hereinafter referred to as an image data file 14-n) As described later, not only the images taken substantially at the same time, but also the image data file of the images registered in the album (contained in the album) is stored without discrimination. Therefore, the file name of the image data file 14-n about the images taken substantially at the same time by the camera 10 is added in the shooting order to a shooting list 16 (“SHOT”) shown in the album list file 15. Accordingly, when the images taken substantially at the same time are transferred from the camera 10 to the PC 40, the camera 10 searches the image root folder 12 for the image data file 14-n having the file name shown in the shooting list 16, and transfers it to the PC 40. The PC 40 stores the image data file 14-n transmitted from the camera 10 as the taken image data files 43-1, 43-2, 43-n, . . . (hereinafter referred to as a taken image data file 43-n) in a taken image folder (“MYCAMERA” folder) 42. The taken image folder 42 is provided in a storage area of an HDD (hard disk drive) 41 of the PC 40.

The album list file (“ALBUM.PVM” file) 15 indicates the relationship (dependency) between each image data file 14-n and the album containing the image data file 14-n (to which the image data file 14-n belongs), and the relationship is represented by an album list 17 in which the file name of each file is arranged for each album containing the file. In the sequence of the file names in the album list 17, the header includes the file name of the image data file about the cover image corresponding to the cover of the album. The cover image corresponds to the designated image.

As described above, the album list file 15 also shows the shooting list 16.

In the present embodiment, the number of albums managed by the album list 17 is predetermined, and each album is assigned the name such as “ALBUM1”, “ALBUM2”, “ALBUM3”, etc.

The album list file 15 is transmitted from the PC 40 together with the image data file 14-n showing the images contained in the album. When the image data file 14-n and the album list file 15 are transmitted from the PC 40, the camera 10 stores the image data file 14-n in the image storage folder 13, and the album list file 15 is overwritten immediately below the root directory in the record area of the memory card 11. However, at this time, the shooting list 16 before the overwrite is stored as is. Furthermore, when the memory card 11 having no album list file 15 is attached to the camera 10, it is necessary to describe in the shooting list 16 the information about the image taken by the camera 10. Therefore, the album list file 15 is newly generated and stored on the memory card 11.

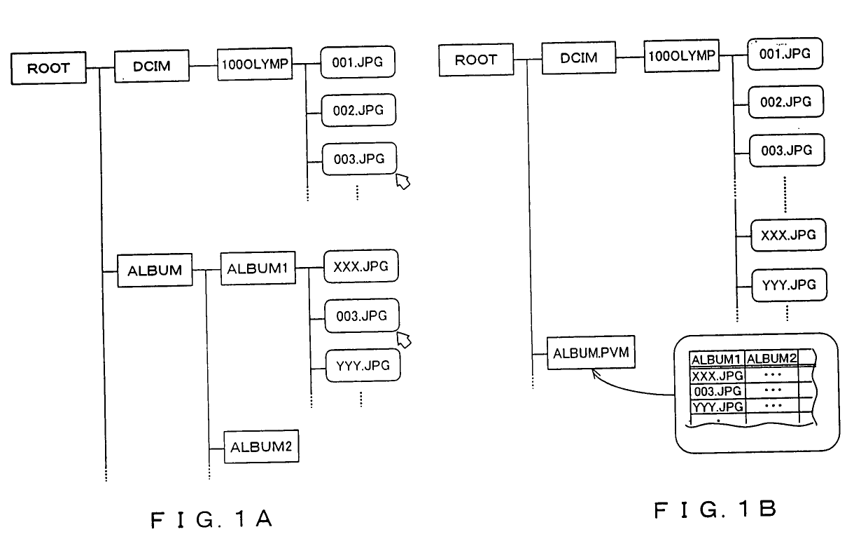

As described above, the management structure of the image data file on the memory card 11 in the camera 10 according to the present invention is the management structure using an image list file as shown in FIG. 1B, and is characterized in that the file name of the image data file for the cover image corresponding to the cover of the album is added to the head of the sequence of file names in the album list 17.

For simple explanation, it is assumed in the present embodiment that file names of the data files having difference data contents do not duplicate in the image root folder 12. Therefore, only the file name in the shooting list 16 and the album list 17 can uniquely designate the image data file 14-n in the image root folder 12. For example, although the file names of the image data file 14-n duplicate in the image root folder 12 with the information about the storage position, etc. of a file added to the shooting list 16 and the album list 17 in addition to a generation date and time of a file and a file name, the image data file 14-n can be uniquely designated.

FIGS. 2B and 2C are explained below.

FIGS. 2B and 2C show the hardware configurations of the camera 10 and the PC 40 shown in FIG. 2A. FIG. 2B shows the configuration of the camera 10. FIG. 2C shows the configuration of the PC 40.

In FIG. 2B, a capturing unit 23, an image processing unit 24, RAM 25, memory I/F 26, a display processing unit 27, a USB I/F 29, and a CPU 30 are connected to a bus 33, and can communicate various data with one another under the management of the CPU 30.

A subject image formed by a lens 21 is converted to an electric signal by a capture unit 22 which is, for example, a CCD (charge coupled device) and input to the capturing unit 23. The capturing unit 23 amplifies the input electric signal to a predetermined value, performs an analog-to-digital conversion, and outputs the image data indicating the image representing the subject image.

The image processing unit 24 performs image processing such as a γ correction, edge emphasis, a white balance correction, etc. of an image represented by the image data on the image data output from the capturing unit 23. When image data is recorded on the memory card 11, a data compressing process is performed as necessary on the image data. When an image represented by the image data recorded on the memory card 11 is regenerated and displayed, a data decompressing process is performed as necessary on the image data read from the memory card 11.

The RAM 25 is random access memory for use as a work area as necessary when the image processing unit 24 and the CPU 30 perform various processes.

The memory I/F 26 is an interface for connection of the memory card 11 to the bus 33, and enables various data to be written and read to and from the memory card 11 under the management of the CPU 30.

The display processing unit 27 performs a digital-to-analog conversion on the image data received through the bus 33, and transmits the result to the display unit 28.

The display unit 28 is, for example, an LCD (liquid crystal display), and displays an image represented by image data input to the display processing unit 27.

The USB I/F 29 is an interface for connection of the USB bus 60 shown in FIG. 2A to the bus 33, and enables various data to be communicated between the camera 10 and the PC 40.

The CPU (central processing unit) 30 controls the entire operation of the camera 10.

ROM 31 is read-only memory storing a control program executed by the CPU 30 and various data used as necessary when the program is executed, and the CPU 30 can control the above-mentioned operations by executing the control program.

An operation input unit 32 is a switch operated by a user of the camera 10, obtains an instruction from a user associated with the contents of an operation, and passes it to the CPU 30.

Described below is the configuration of the PC 40 shown in FIG. 2C.

In FIG. 2C, a CPU 51, ROM 52, RAM 53, an HDD 41, an input unit 54, a data read device 55, a display unit 56, and a USB I/F 57 are connected to a bus 58, and can communicate various data with one another under the management of the CPU 51.

The CPU 51 controls the entire operation of the PC 40.

The ROM 52 is read-only memory storing a basic control program executed by the CPU 51 and various data used as necessary when the program is executed, and the CPU 51 can control the entire operation of the PC 40 by executing the basic control program.

The RAM 53 is random access memory for use as a work area as necessary when the CPU 51 performs various processes.

The HDD 41 is a magnetic disk storage device, and can store carious control programs executed by the CPU 51 and various data used as necessary when the programs are executed in addition to the above-mentioned taken image data file 43-n.

The input unit 54 is configured by, for example, a pointing device such as a mouse, etc., a keyboard device, etc., and obtains an instruction from a user associated with the contents of the operation for the devices.

The data read device 55 is, for example, a CD (compact disc)-ROM drive, a DVD (digital versatile disk)-ROM drive, and reads various data recorded on a record medium 59 such as CD-ROM, DVD-ROM, etc. The image management software described later is recoeded on the record medium 59 and distributed. In the PC 40, the data read device 55 reads the image management software from the record medium 59 and stores it in the HDD 41 in advance. When the user issues an instruction to execute the management software to the input unit 54, the CPU 51 reads the image management software stored in the HDD 41 and executes it.

The record medium 59 can be a display device of a computer system for functioning as a program server connected to a communication circuit such as the Internet, etc. In this case, the transmission signal obtained by modulating the carrier wave using the data signal representing the image management software is transmitted from the program server to the computer through the communication circuit which is a transmission medium. In the PC 40, a connection device to the communication circuit is provided to receive the transmission signal, demodulate the signal, and represent the image management software, thereby allowing the image management software to be executed by the CPU 51.

The display unit 56 is an LCD, a CRT (cathode ray tube), etc., and displays a predetermined image at an instruction of the CPU 51.

The USB I/F 57 is an interface for connection of the USB bus 60 shown in FIG. 2A to the bus 58, and enables various data to be communicated between the PC 40 and the camera 10.

The configuration of the PC 40 is provided for most standard computers.

Described below is the image management software executed by the CPU 51 of the PC 40. The software presents the PC 40 with the functions of fetching an image taken by the camera 10 to the PC 40, generating and editing an album, generating a cover image corresponding to the cover of the album, transferring the album to the camera 10, etc. Various controlling processes performed by the CPU 51 by executing the image management software are explained below.

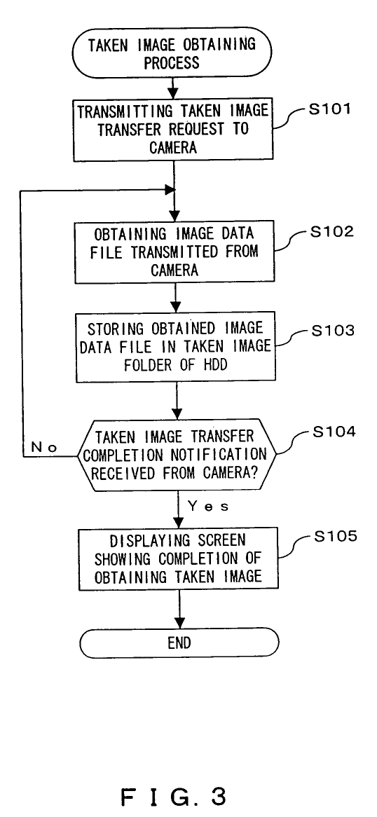

FIG. 3 is a flowchart showing the contents of the taken image obtaining process.

The taken image obtaining process is a process for receiving from the camera 10 the image data file 14-n about the image taken by the camera 10, and storing the file as the taken image data file 43-n in a taken image folder 42 in the HDD 41. The execution of the process is started when an instruction to start the process is input to the input unit 54 in the PC in which the image management software is executed, for example, an operation of clicking a button display indicating “reading an image” is performed by a pointer on the input unit 54 on the screen displayed on the display unit 56 by the execution of the image management software. The process can be automatically started when the CPU 51 detects that the PC 40 and the camera 10 are connected through the USB bus 60.

First, in step S101, the data addressed to the camera 10 to request a taken image to be transferred is transmitted from the USB I/F 57.

Upon receipt of the transfer request data transmitted through the USB bus 60, the camera 10 refers to the shooting list 16 stored on the memory card 11, and reads the image data file 14-n designated by the file name from the image root folder 12. The read image data file 14-n is transmitted by the CPU 30 from the USB I/F 29 to the PC 40. When the transfer of all image data files 14-n containing the designated file names in the shooting list 16 is completed, the process of transmitting the data indicating the notification of the completion of the transfer of taken images is performed by the CPU 30.

In step S102, the process of the USB I/F 57 obtaining the image data file 14-n transmitted from the camera 10 through the USB bus 60 is performed. In step S103, the obtained image data file 14-n is stored as the taken image data file 43-n in the taken image folder 42 of the HDD 41.

Then, in step S104, it is determined whether or not the data indicating the notification of the completion of the transfer of the taken image has been transmitted from the camera 10. If the notification has been received (the determination result is YES), then the screen displaying the completion of acquisition of the taken image is displayed in step S105, thereby terminating the taken image obtaining process. If the notification has not been received (the determination result is NO), control is returned to step S102, and the above-mentioned processes are repeated.

Described above is the taken image obtaining process.

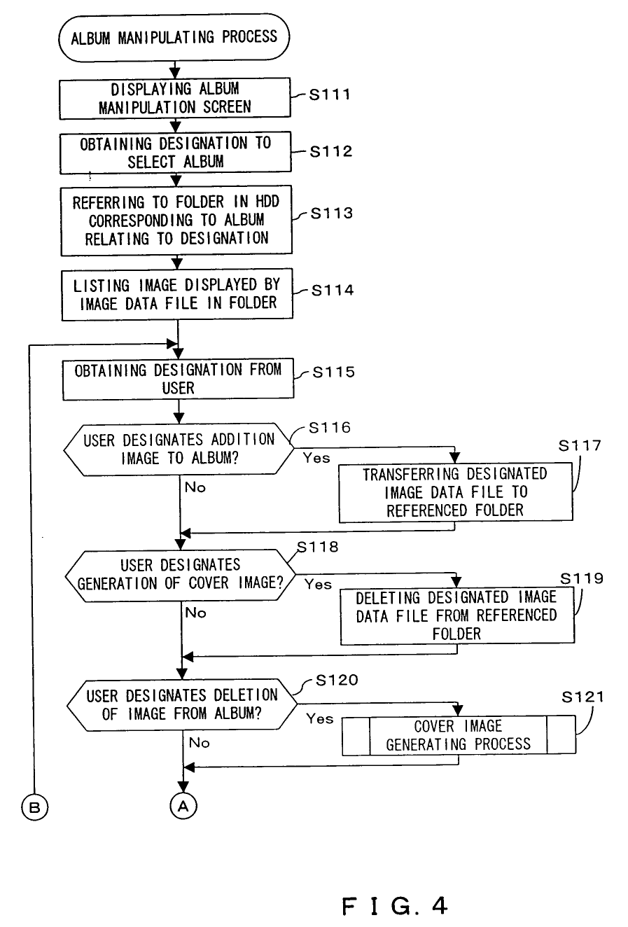

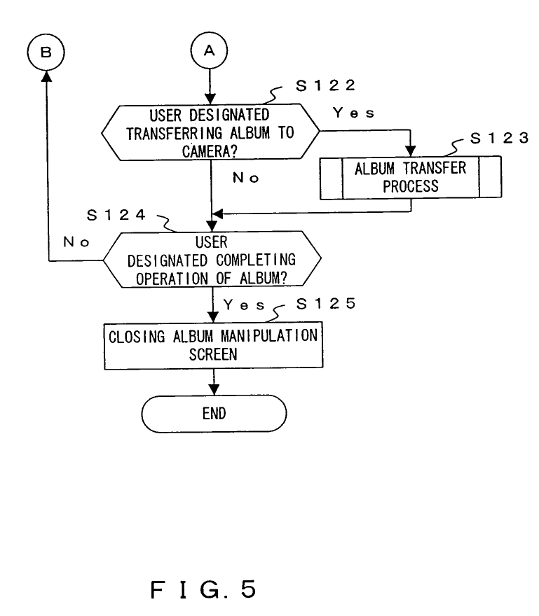

FIGS. 4 and 5 are explained below. FIGS. 4 and 5 are flowcharts showing the contents of the album manipulating process. The process is performed to edit an album, generate a cover image corresponding to the cover of an album, compose the title characters for the cover image, and transfer an album to the camera 10. The execution of the process is started when an instruction to start the process is input to the input unit 54 in the PC in which the image management software is executed, for example, an operation of clicking is performed by a pointer to manipulate an album on the input unit 54 on the screen displayed on the display unit 56 by the execution of the image management software.

First, in step S111 shown in FIG. 4, the process of displaying the album manipulation screen on the display unit 56 is performed.

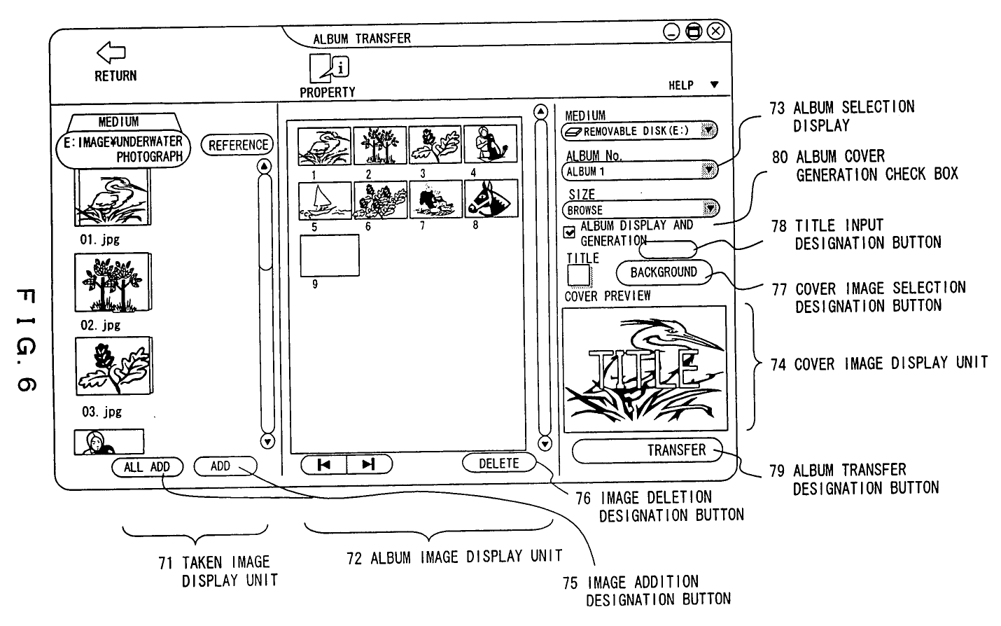

FIG. 6 shows an album manipulation screen. In the present embodiment, at this time, the taken image data file 43-n stored in the taken image folder 42 in the HDD 41 is read, and the images indicated by each of the taken image data files 43-n (the image is assumed to be a “taken image”) are listed on the taken image display unit 71 shown in FIG. 6.

In step S112, a user performs the process of obtaining the designation of the selection of an album to be operated from the input unit 54. The selection of an album is performed by the pointer clicking operation, etc. on an album selection display 73 shown in FIG. 6.

In step S113, what corresponds to an album relating to the designation obtained in the process in the previous step (the folder is referred to as a “album folder”) is referred to in the folder stored in the HDD 41.

In step S114, the image data file stored in the album folder being referenced is read, and a list of images (the images are referred to as “album images”) represented by the read image data file is displayed on the album manipulation screen being displayed on the display unit 56. In the example of the screen shown in FIG. 6, the list of images is displayed on an album image display unit 72. When the album folder includes an image data file of a cover image, the cover image represented by the image data file is displayed on a cover image display unit 74.

In step S115, the designation from a user corresponding to the operation performed on the input unit 54 is obtained. In the example of the screen shown in FIG. 6, the designation is performed by a clicking operation of any of an image addition designation button 75, an image deletion designation button 76, a cover image selection designation button 77, a title input designation button 78, and an album transfer designation button 79.

In step S116, it is determined whether or not the designation obtained in the process in step S15 refers to the image addition designation button 75 in FIG. 6, that is, whether or not the designation refers to the addition to the album of taken images. Only when the determination result is YES, the image data file of the taken images relating to the designation is transferred to the album folder being referenced.

In FIG. 6, an “add all” button and an “add” button are provided as image addition designation buttons 75. The “add all” button refers to the designation to transfer the image data file of taken images to an album folder being referenced, and the “add” button refers to the designation to transfer the image data file of taken images selected in advance in the operation performed on the input unit 54 to the album folder being referenced.

In the example of the screen shown in FIG. 6, when the image data file is transferred, the display position of the taken images relating to the designation is transferred from the taken image display unit 71 to the tail of the image list of the album image display unit 72.

In step S118, it is determined whether or not the designation obtained in the process in step S115 refers to the image deletion designation button 76 in FIG. 6, that is, whether or not the designation refers to the deletion of an album image from the album. Only when the determination result is YES, the image data file of album images relating to the designation is deleted from the album folder being referenced in step S119.

In FIG. 6, clicking the image addition designation button 75 refers to the deletion of the image data file of what is selected in advance in the album images in the operation performed on the input unit 54 from the album folder being referenced.

In the example of the screen shown in FIG. 6, when the image data file is transferred, the display of the album images relating to the designation is deleted from the image list of the album image display unit 72.

In step S120, it is determined whether or not the designation obtained in the process in step S115 refers to the generation of a cover image, that is, whether or not it refers to the cover image selection designation button 77 or the title input designation button 78 in FIG. 6. Only when the determination result is YES, the cover image generating process is performed in S121. The details of the cover image generating process are described later.

Control is passed to the process in FIG. 5, and it is determined in step S122 whether or not the designation obtained in the process in step S115 shown in FIG. 4 refers to the album transfer designation button 79, that is, whether or not the designation refers to the transfer to the camera 10 of the album. Only when the determination result is YES, the album transfer process is performed in step S123. The album transfer process is described later in detail.

In step S124, it is determined whether or not the designation obtained in the process in step S115 shown in FIG. 4 refers to the end of the album manipulating process. If the determination result is YES, the album manipulation screen displayed on the display unit 56 is closed in step S125, and then the album manipulating process terminates. If the determination result in step S124 is NO, control is returned to step S115 shown in FIG. 4, and the above-mentioned processes are repeated.

The above-mentioned process is the album manipulating process.

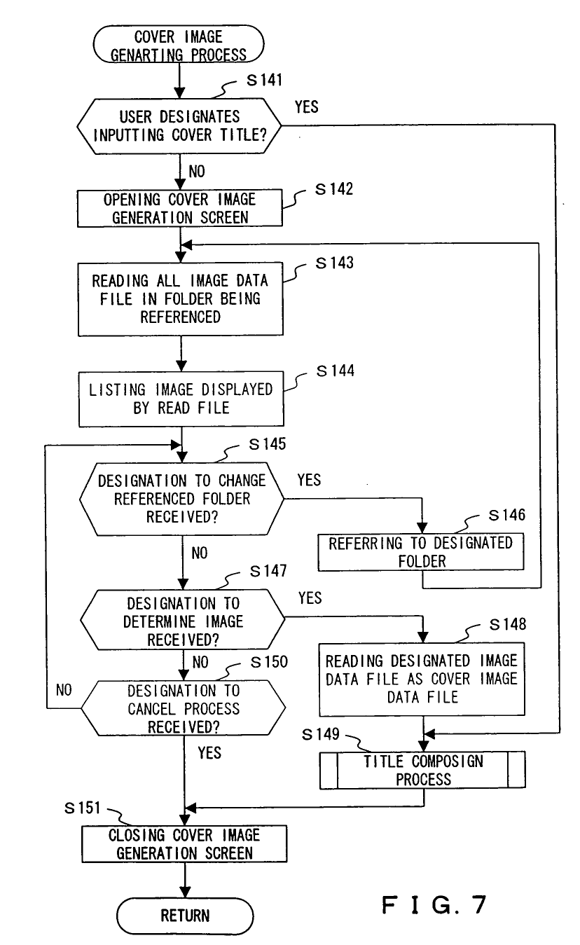

Then, the cover image generating process which is the process in step S121 (FIG. 4) in the album manipulating process is explained below. FIG. 7 is a flowchart showing the contents of the cover image generating process.

First, in step S141, it is determined whether or not the designation obtained in the process in step S115 in the album manipulating process refers to the title input designation button 78, that is, whether or not it refers to the input of a title for the cover image. If the determination result is YES, control is passed to the title composing process in step S149. The title composing process is described later in detail. If the determination result is NO, that is, if it refers to the cover image selection designation button 77, control is passed to step S142.

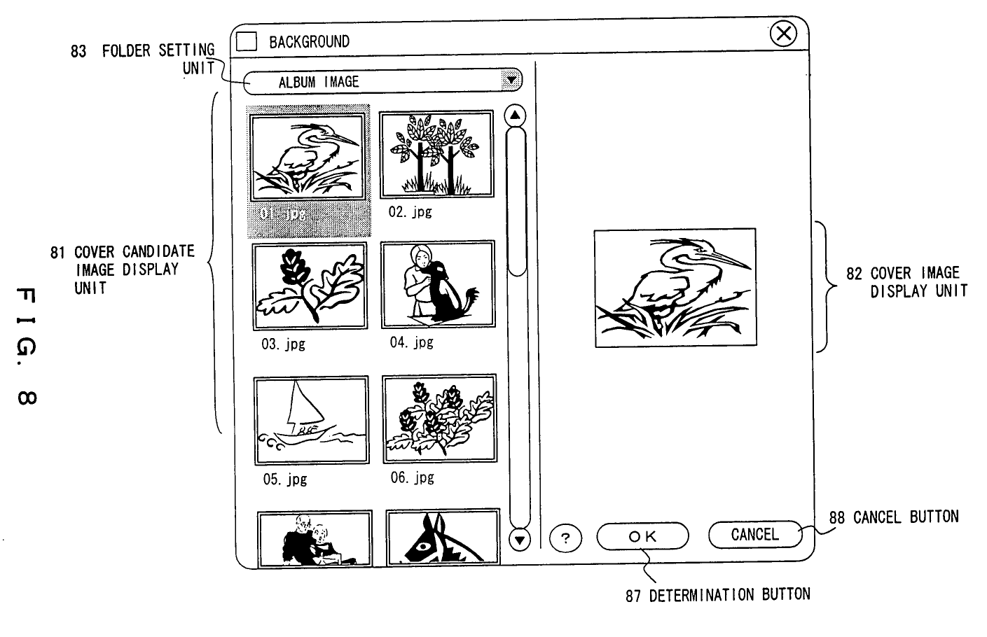

In step S142, the cover image generation screen is opened (displayed on the display unit 56). FIG. 8 illustrates a cover image generation screen.

In step S143, all image data files in the album folder being referenced are read. In step S144, a list of album images displayed in each of the read image data files is displayed on the cover image generation screen being displayed on the display unit 56. In the example of the screen shown in FIG. 8, the list of album images is displayed on a cover candidate image display unit 81. The album images are candidates for the cover image, and when the user performs an operation corresponding to the designation of selecting an image from among the album images using the input unit 54, the image is displayed on the cover image display unit 82.

In step S145, it is determined whether or not the designation of changing the candidate image for the cover image has been obtained by changing the folder to be referenced, that is, whether or not the designation of changing the folder to be referenced has been obtained in an operation such as a clicking operation using the folder setting unit 83 in the example of the screen shown in FIG. 8. If the determination result is YES, then a folder relating to an obtained designation is referred to in step S146, control is returned to step S143, and the above-mentioned processes are repeated. The process enables the cover image of the album to be treated in the manipulation of an album to be selected from among the images other than the album images contained in the album. If the determination resulting step S145 is NO, control is passed to step S147.

In step S147, it is determined whether or not the designation to determine a cover image has been obtained, that is, whether or not an operation has been performed on a determination button 84 in the example of the screen shown in FIG. 8. If the determination result is YES, the file name of the image data file of the image relating to the determine designation is read as a image data file (cover image data file) of a cover image, and is temporarily stored in a predetermined area of the RAM 53 in step S148, the title composing process is performed in step S149, and control is passed to step S151. In the example of the album manipulation screen shown in FIG. 6, the image which has been displayed on the cover image display unit 74 up to this point is replaced with the cover image relating to the determine designation.

If the determination result in step S147 is NO, control is passed to step S150.

In step S150, it is determined whether or not the designation to cancel the cover image generating process has been obtained, that is, whether or not an operation on a cancel button 85 has been performed in the example of the screen in FIG. 8. If the determination result is YES, control is passed to step S151. If the determination result is NO, control is returned to step S145, and the above-mentioned processes are repeated.

In step S151, the cover image generation screen being displayed on the display unit 56 is closed (erased) Then, the cover image generating process is terminated, and control is returned to the album manipulating process shown in FIG. 4.

Described above is the cover image generating process.

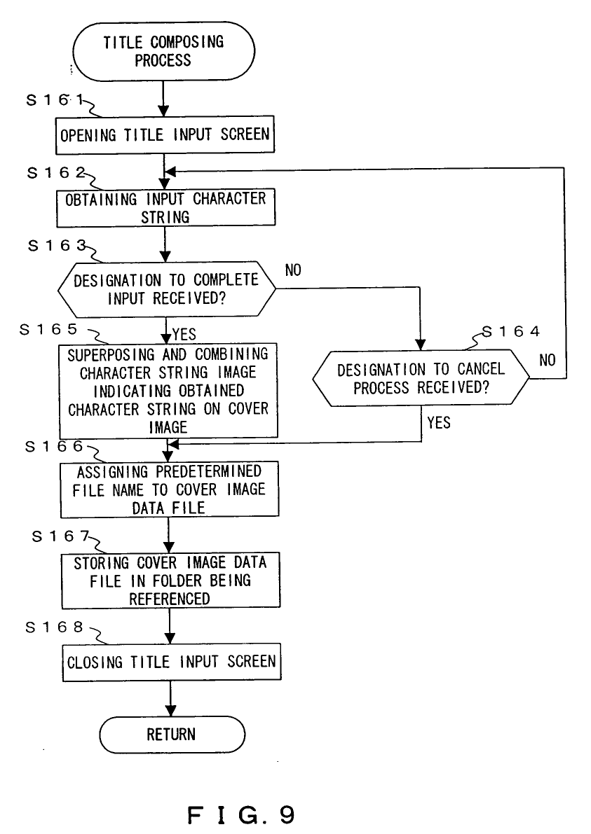

The title composing process in step S149 in the above-mentioned cover image generating process is explained below. FIG. 9 is a flowchart showing the contents of the title composing process.

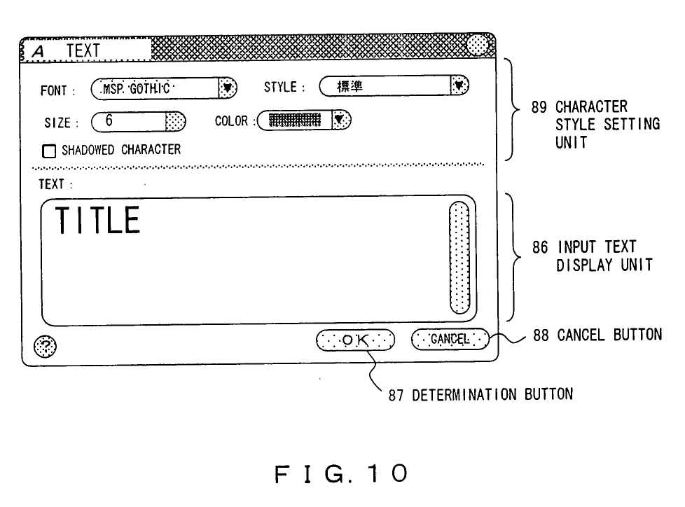

In step S161, the title input screen is opened (displayed on the display unit 56). FIG. 10 shows an example of the title input screen.

In step S162, the contents of the input character string corresponding to the operation performed by the user through the input unit 54 is obtained. In the example of the screen shown in FIG. 10, the contents of the character string obtained at this time is displayed on an input text display unit 86.

In step S163, it is determined whether or not the input of a character string is completed and the designation to determine a character of a title has been obtained, that is, whether or not an operation on a determination button 87 has been performed in the example of the screen shown in FIG. 10. If the determination result is YES, control is passed to step S165. If the determination result is NO, it is determined in step S164 whether or not the destination to cancel the title composing process has been obtained, that is, whether or not an operation on a cancel button 88 has been performed in the example of the screen shown in FIG. 10. If the determination result is YES, control is passed to step S166. If the determination result is NO, control is passed to step S166. If the determination result is NO, control is returned to step S162, and the above-mentioned processes are repeated.

In step S165, a character string image representing a character string obtained in the process in step S162 is generated, and the generated character string image is superposed onto the cover image represented by the cover image data file and stored in a predetermined area in the RAM 53 in the process in step S147 in the cover image generating process (FIG. 7), and the image data file of the obtained composite image is stored again in the area of the RAM 53.

In the example of the screen shown in FIG. 10, a character string image of a shape, size, and color set in a character style setting unit 89 is generated.

In step S166, a predetermined file name is assigned to the cover image data file stored in a predetermined area of the RAM 53. In step S167, the cover image data file is added to the album folder being referenced and is then stored. In the example of the screen of the album manipulation screen shown in FIG. 6, the image displayed up to this point on the cover image display unit 74 is replaced with the display image with composite characters.

In step S168, the title input screen being displayed on the display unit 56 is closed (erased). Afterwards, the title composing process is terminated, and control is returned to the cover image generating process shown in FIG. 7.

The title composing process is described above. Thus, by composing an image of a character string representing a title for the cover image, the camera 10 having no font data of the characters such as kanji, etc. can display the title of the album, and the characters representing the title can be displayed in various styles.

Described below is the album transfer process that is the process in step S123 (FIG. 5) in the album manipulating process.

First, in step S171, the name of the album corresponding to the album folder being referenced is obtained.

In step S172, the data addressed to the camera 10 to request to transmit the album list file 15 stored in the memory card 11 of the camera 10 is transmitted. The process performed by the camera 10 which has received the transmit request is described later.

In step S173, in response to the request, the album list file 15 transmitted from the camera 10 is received and obtained by the USB I/F 57.

As described later in detail, the data notifying that there is no album list file 15 can be transmitted from the camera 10. When the data is transmitted, the notification is received and obtained. In step S174, it is determined whether or not the album list file 15 has been stored in the camera 10. If not, (the determination result is NO), the album list file 15 is newly generated in step S175.

In step S176, the list of the album having the album name obtained in the process in step S171 in the album list 17 of the album list file 15 is referred to, and a file name of the image data file contained in the album folder in the HDD 41 being referenced is added to the tail of the sequence of the file names of the image data file shown in the list.

In step S177, it is determined whether or not image data file of a cover image is stored in the album folder being referenced. If the determination result is YES, control is passed to step S178. If it is NO, control is passed to step S181.

In step S178, it is determined whether or not a transfer instruction for a title image has been obtained. If the determination result is YES, control is passed to step S180. If it is NO, control is passed to step S179. The transfer instruction for the title image is determined depending on whether or not a check mark has been given to the album cover image generation check box 80 in the example of the screen of the album manipulation screen shown in FIG. 6.

In step S179, all image data files contained in the album folder being referenced excluding the cover image are transmitted from the USB I/F 57 to the camera 10. Afterwards, control is passed to step S182.

In step S180, in the list of the albums to which file names are added in the process in step S176, the file name of the image data file of the cover image stored in the album folder being referenced is transferred and added to the head of the list. By the process, the file name of the image data file of the cover image is shown at the head of the list of the albums which is the album list 17.

By changing the contents of the process in step S180 and transferring and adding the file name of the image data file of the cover image stored in the album folder being referenced to the tail of the list, the cover image can be regenerated and displayed at the end of the album image when it is sequentially regenerated. This enables the cover image generated in the above-mentioned process to be treated as if it were the back cover of the album.

In step S181, all of the image data files contained in the album folder being referenced are transmitted from the USB I/F 57 to the camera 10.

In step S182, the album list file 15 in which a file name is added to the album list 17 is transmitted from the USB I/F 57 to the camera 10, the album transfer process is terminated, and control is returned to the album manipulating process shown in FIG. 5.

The album transfer process is described above.

Described below is the controlling processes performed by the CPU 30. The processes are realized by the CPU 30 executing the control program stored in the ROM 31.

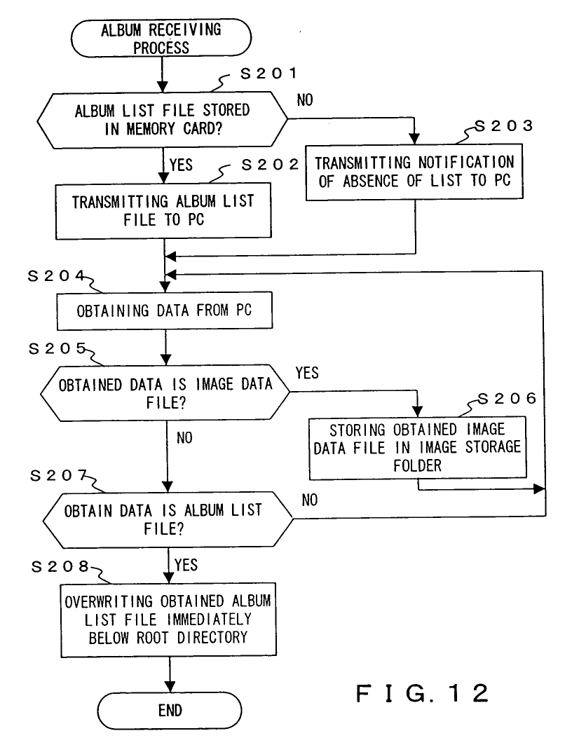

First, the album receiving process is described below by referring to the flowchart shown in FIG. 12. The process is performed to receive by the 10 the data relating to the album transmitted from the PC 40, and is started when the album transfer process is executed by the PC 40 and the CPU 30 detects that the USB I/F 29 has received the data indicating a request to transmit the album list file 15.

First in step S201, the memory card 11 is detected to determine whether or not the album list file 15 is stored. If it is stored (the determination result is YES), the album list file 15 is read in step S202 and transmitted from the USB I/F 29 to the PC 40. If it is not stored (determination result is NO), the data notifying that there is no album list file 15 is transmitted from the USB I/F 29 to the PC 40. The data transmitted in the process in step S202 or S203 is received by the PC 40 that performs the process in step S173 in the above-mentioned album transfer process.

In step S204, depending on the data transmitted in the process in step S202 or S203, the data transmitted from the PC 40 is received and obtained by the USB I/F 29.

In step S205, it is determined whether or not the data obtained in the process in the preceding step refers to an image data file. If the determination result is YES, the obtained image data file is stored in the image storage folder 13 in the image root folder 12 of the memory card 11. Afterwards, control is returned to step S204, and the above-mentioned processes are repeated.

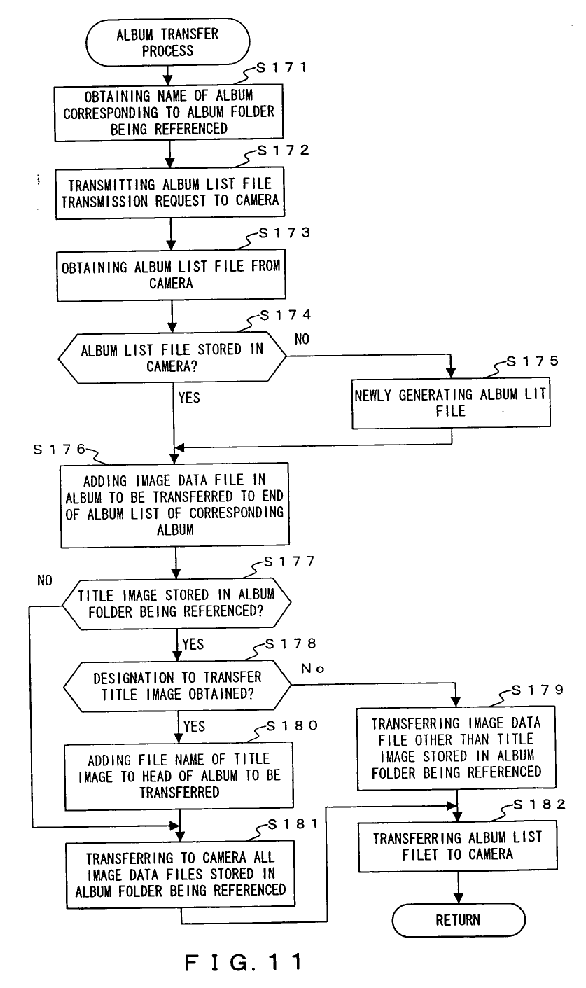

When the determination result in step S205 is NO, it is determined in step S207 whether or not the data obtained in the process in step S204 refers to the album list file 15. In the PC 40 that performs the album transfer process, since the album list file 15 is transmitted after all image data files to be transferred have been transmitted in the processes in steps S179, S181, and S182 shown in FIG. 11, it is assumed that the album transfer process performed by the PC 40 has terminated if the determination result in step S207 is YES, and control is passed to step S208. If the determination result in step S207 is NO, control is returned to step S204, and the above-mentioned processes are repeated.

In step S208, the album list file 15 obtained in the process in step S204 is overwritten immediately below the root directory of the memory card. At this time, the shooting list 16 stored in the album list file 15 before the overwriting is held as is. Afterwards, the album receiving process terminates.

Described above is the album receiving process.

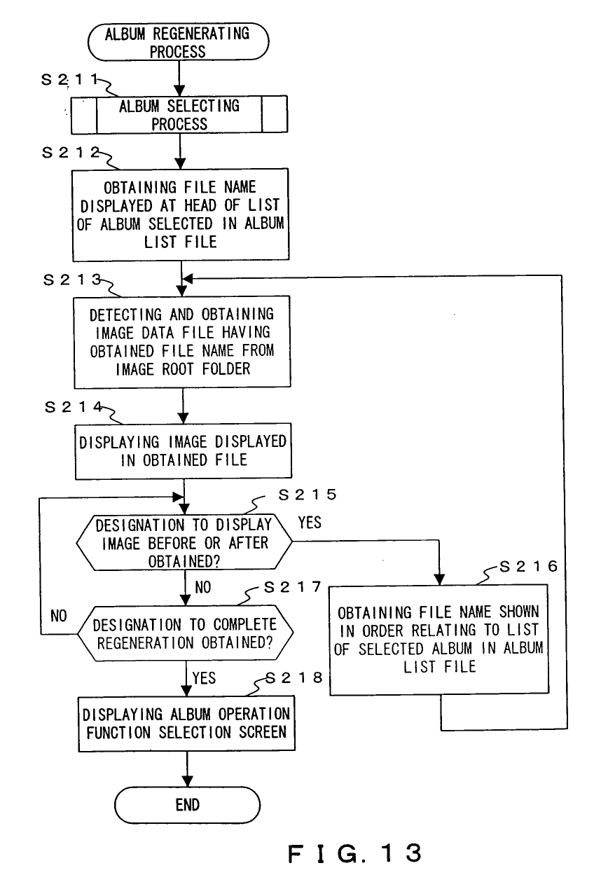

FIG. 13 is a flowchart showing the contents of the album regenerating process described below. The process is performed to allow the camera 10 to browse the album transmitted from the PC 40.

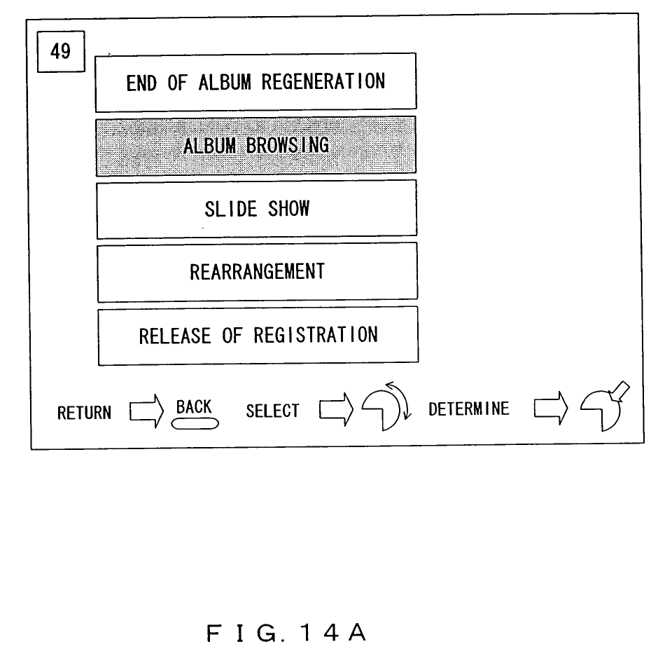

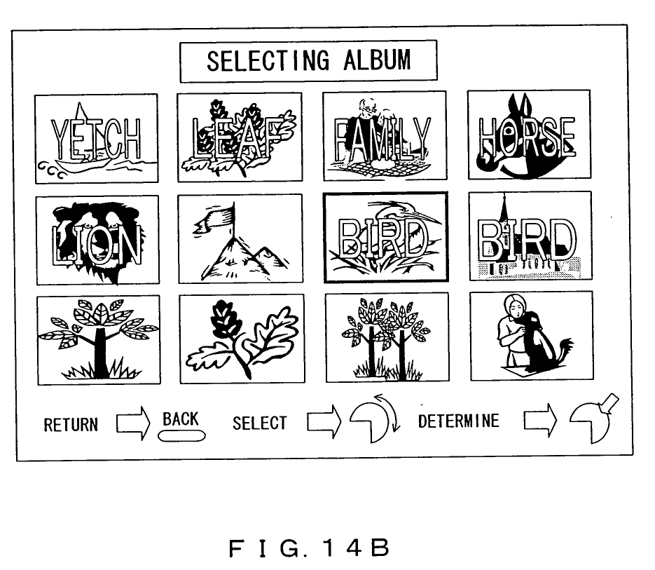

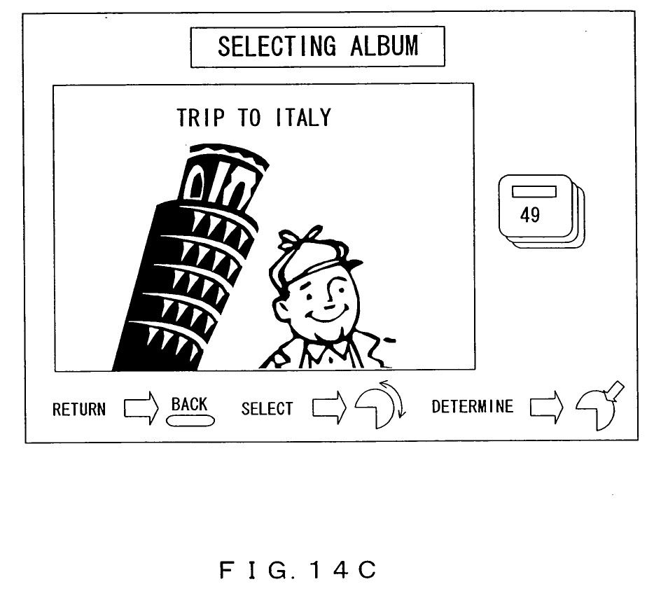

The album regenerating process is started if an operation for the operation input unit 32 selects the function of “regenerating an album” when the display unit 28 displays the function selection screen relating to the manipulation of an album as illustrated in FIG. 14A by a user operating the operation input unit 32.

First, the album selecting process is performed in step S211. This process is performed to select what is browsed from among a plurality of albums stored in the camera 10, and is described later in detail.

In step S212, the album list 17 in the album list file 15 stored in the memory card 11 is referred to, and the leading file name of the file names arranged associated with the albums selected in the process in step S211 is obtained.

In step S213, the image data file 14-n which is the file name obtained in the process performed immediately before is detected and obtained in the image root folder 12.

In step S214, designation is given to the image processing unit 24 and the display processing unit 27 to display on the display unit 28 an image represented by the file obtained in the preceding step.

In step S215, it is determined whether or not the designation to change the image displayed on the display unit 28 from the image being displayed to the image before or after has been obtained. If the designation has been obtained (the determination result is YES), control is passed to step S216. If it has not been obtained (the determination result is NO), control is passed to step S217.

In step S216, the album list 17 indicated by the album list file 15 stored in the memory card 11 is referred to, and the file name relating to the designation obtained in the process in step S215 is obtained among the file names arranged as associated with the album selected in the process in step S211. Afterwards, control is returned to step S213, and the above-mentioned processes are repeated.

In step S217, it is determined whether or not the designation to terminate the regeneration of an album by the operation performed by the operation input unit 32 has been obtained. If the designation has been obtained (the determination result is YES), the album manipulation facility selection screen as shown in FIG. 14A is displayed again in step S218. Afterwards, the album regenerating process terminates. If the determination result in step S217 is NO, control is returned to step S215, and the above-mentioned processes are repeated.

Described above is the album regenerating process.

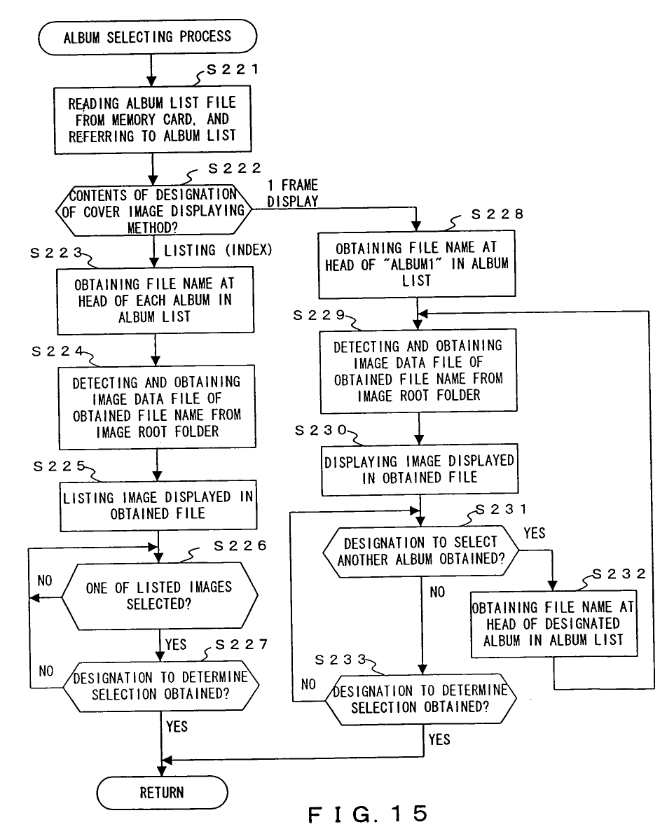

The album selecting process to be performed in step S211 in the above-mentioned album regenerating process is described below. FIG. 15 is a flowchart showing the contents of the album selecting process.

First, in step S221, the album list file 15 is read from the memory card 11, and the album list 17 is referred to.

In step S222, it is determined what are the contents of the designation about the displaying method on the display unit 28 of the cover image of an album performed by the user operation through the operation input unit 32. If the contents of the designation refers to the listing of the cover images of a plurality of albums, control is passed to step S223. If the contents of the designation refers to the display for each cover image (frame by frame), control is passed to step S228.

In step S223, the leading file name in the sequence of the file names of the image data file 14-n of each album in the album list 17 is obtained. The leading file name relates to the image data file 14-n of the cover image about each album in the process in step S180 (FIG. 11) in the above-mentioned album transfer process.

In step S224, the image data file 14-n having the file name obtained in the process in the preceding step is detected and obtained from the image root folder 12 of the memory card 11.

In step S225, designation is given to the image processing unit 24 and the display processing unit 27 to allow the cover image represented by the image data file 14-n obtained in the process in the preceding step to be displayed on the display unit 28.

In step S226, it is determined whether or not the designation to select one of the cover images listed on the display unit 28 has been issued in the operation through the operation input unit 32, and the process in step S226 is repeated until the designation is issued (until the determination result is YES).

In step S227, it is determined whether or not the designation to select one of the designated cover images has been issued in the operation through the operation input unit 32 by a user. If the determine designation has been issued (the determination result is YES), the album selecting process terminates, and control is returned to the album regenerating process shown in FIG. 13. When the determine designation is not issued (the determination result is NO), control is returned to step S226, and the above-mentioned processes are repeated.

In step S228, the leading file name in the image data file 14-n relating to the album name “ALBUM1” in the album list 17, that is, the file name of the image data file 14-n which is the cover image of the album, is obtained.

In step S229, the image data file 14-n which is the file name obtained in the process performed immediately before is obtained from the image root folder 12 of the memory card 11.

In step S230, designation is given to the image processing unit 24 and the display processing unit 27, and the cover image represented by the image data file 14-n obtained in the process in the preceding step is displayed on the display unit 28.

In step S231, it is determined whether or not the designation to select an album other than the album displaying a representative image on a display unit 18 has been obtained. If the designation has been obtained (the determination result is YES), the leasing file name in the sequence of file names of the image data file 14-n about the album names relating to the designation in the album list 17 is obtained in step S232. Afterwards, control is returned to step S229, and the above-mentioned processes are repeated.

If the designation has not been obtained in step S231 (the determination result is NO), it is determined in step S233 in the operation by a user through the operation input unit 32 whether or not the designation to select one of the indicated cover images has been obtained. If the designation has been issued (the determination result is YES), the album selecting process terminates, and control is returned to the album regenerating process in FIG. 13. If the determine designation has not been issued (the determination result is NO), control is returned to step S231, and the according to processes are repeated.

Described above is the album selecting process.

The above-mentioned processes are performed by the CPU 51 of the HDD 41 and the CPU 30 of the camera 10, thereby managing the relationship between an album and the cover image of the album with the consumption of the record capacity of the memory card 11 reduced.

In the above-mentioned embodiments, an album is generated and edited in the PC 40. However, by the CPU 30 of the camera 10 performing the respective processes shown in FIGS. 4, 5, 7, and 9, an album can be generated and edited in the camera 10. In the above-mentioned embodiments, an album is regenerated including the display of a representative image by the camera 10. However, by the CPU 51 of the HDD 41 performing each process shown in FIGS. 11 and 12, the PC 40 can regenerate an album including the display of a representative image.

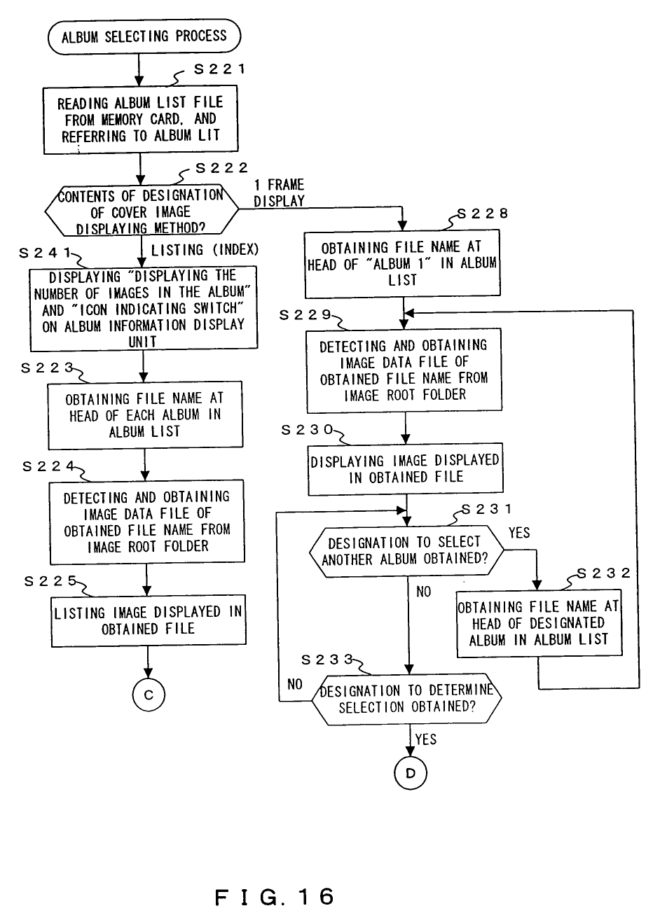

An example of a variation of the album selecting process is described below by referring to FIGS. 16 through 48.

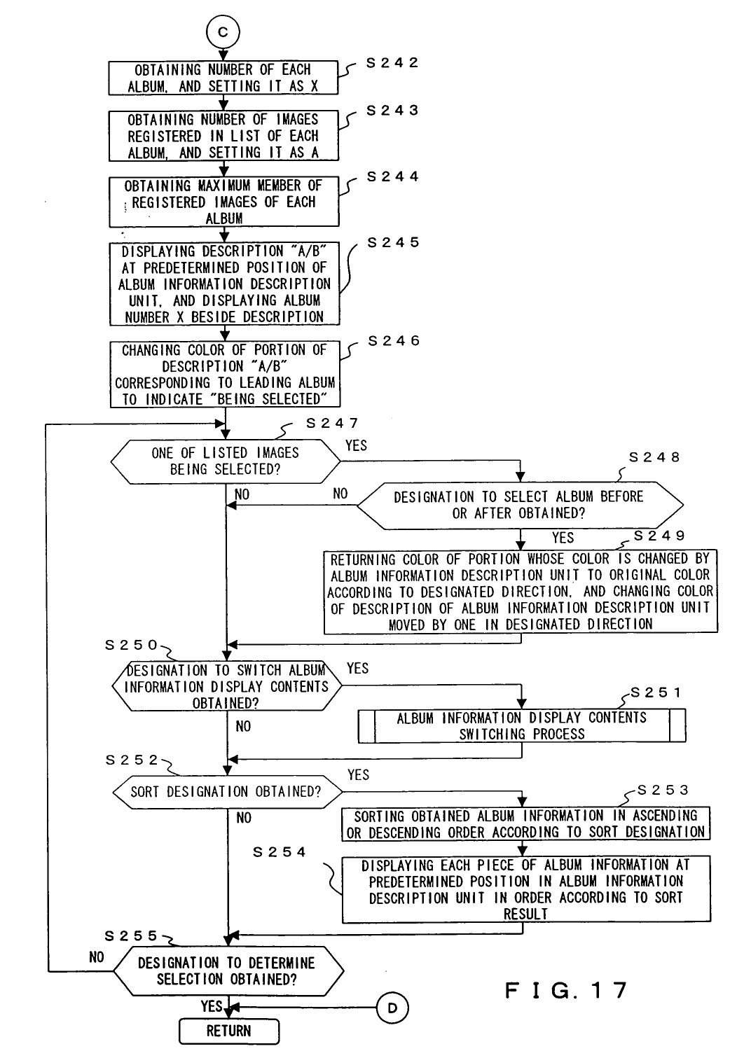

FIGS. 16 and 17 are flowcharts showing the flow of the process of switching and displaying the number of registered images of an album and the number of remaining images to be registered in the album when cover images of a plurality of albums are listed.

In the flowcharts shown in FIGS. 16 and 17, steps S221, S222, S224, S225, and S228 through S233 are the same as those steps in the album regenerating process described above by referring to FIG. 5. Therefore, the explanation is omitted here, and the new steps S241, S242 through S255 in this variation example are explained in detail.

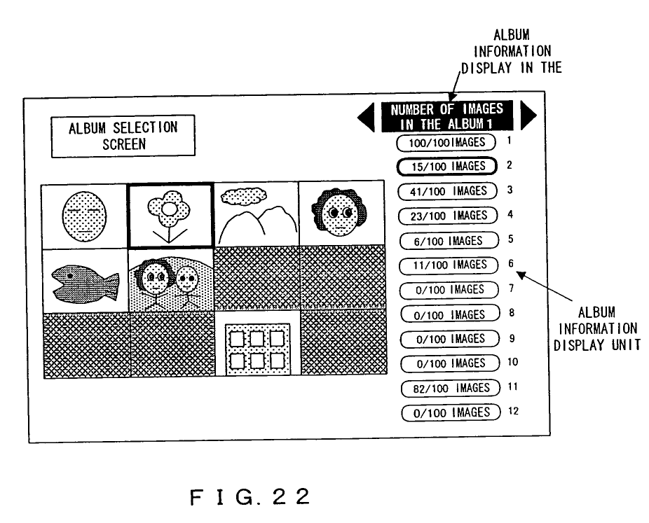

First, in step S222 explained above by referring to FIG. 15, it is determined what are the contents of the designation relating to the method of displaying a cover image of an album on the display unit 28. If the contents of the designation refer to the listing (indexed display) of cover images of a plurality of albums, then “display of the number of images in the album” indicating the number of images registered in an album which one piece of information about each album and “icons” for switching and displaying the information about each album other than “display of the number of images in the album” are displayed on the screen in a predetermined position (album information display contents display unit described later (refer to FIG. 22)).

After performing the processes in steps S223 through 225, the number of each album registered in the album list 17 is obtained (substituted for the variable X) in step S242 shown in FIG. 17. In step S243, each of the number of album images registered in the album list 17 is obtained (substituted for the variable A). In step S244, the maximum number of registered images which is the number of images that can be registered in each album is obtained (substituted for the variable B). In this example, the value of 10 is set as a predetermined value for all albums. That is, B=100.

In step S245, for example, the description of “A/B” is displayed in a predetermined position of the screen listed in step S225, and the album number X is displayed beside the description. In step S246, the color of the description of “A/B” corresponding to the leading album is changed and displayed to indicate “being displayed”.

In step S247, it is determined whether or not the designation to select one of the cover images listed on the display unit 28 has been issued in the operation by a user through the operation input unit 32. If the select designation has been issued (the determination result is YES), then it is determined in step S248, for example, whether or not the select designation refers to the selection of an album before or after the album currently being selected.

If the determination result in step S248 is YES, and when the designation in step S248 refers to the method of sequentially designating the albums, the color of the portion displayed with a changed color in a predetermined position on the screen (album information description unit described later by referring to FIG. 22) is returned to the original color in the direction of the designation, and the color of the album information description unit transferred by one in the designation direction is changed in step S249.

Then, after step S249, or when the determination result is NO in step S247 or S248, it is determined in step S250 whether or not the designation to switch the album information display contents such as the number of registered images of the album which is the number of images configuring an album, the number of remaining images to be registered in the album which is the number of remaining images to be registered in the album, the shooting period of all image configuring the album, the date of the generation of the album, the capacity of all images configuring the album, the quality of an image configuring the album, the information about the type of the image configuring the album, etc. has been obtained.

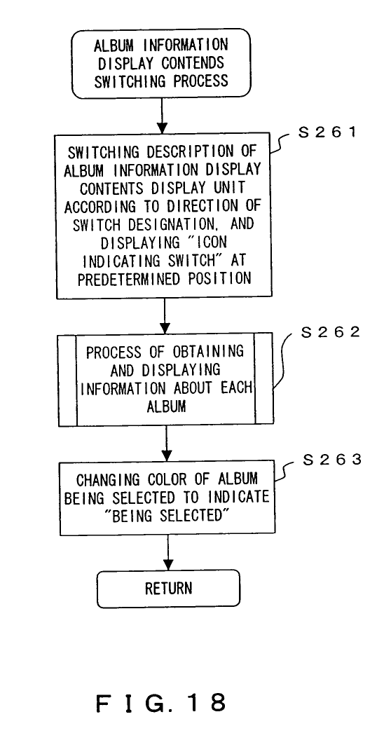

If the determination result is YES, the “album information display contents switching process” described later is performed by referring to the flowchart shown in FIG. 18 in step S251.

When the determination result in step S250 is NO, it is determined in step S252 after the process in step S251 whether or not the sort designation has been obtained. “Sort” refers to rearrange data in an ascending or descending order on the album information such as the number of registered images of the album, the number of remaining images to be registered in the album, the shooting period, the album generation date, the image capacity, the image quality, the image type information, etc.

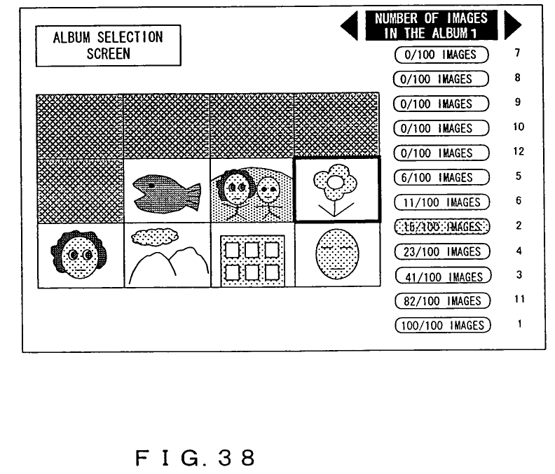

When the determination result in step S252 is YES, the obtained album information is sorted in an ascending or descending order at the sort designation in step S253, and each piece of album information is displayed in a predetermined position in the album information description unit in the order according to the sort result in step S254. An example of displaying a sorting result is described later by referring to FIG. 38.

When the determination result in step S252 is NO, it is determined whether or not the designation to select one of the indicated cover images in the operation by a user through the operation input unit 32 in step S255 after the process in step S254. If the determine designation is issued (the determination result is YES), the album selecting process terminates. If the determine designation has not been issued (determination result is NO), control is returned to step S247, an the above-mentioned processes are repeated.

FIG. 18 is a flowchart showing the flow of the “album information display contents switching process” performed in step S251 shown in FIG. 17.

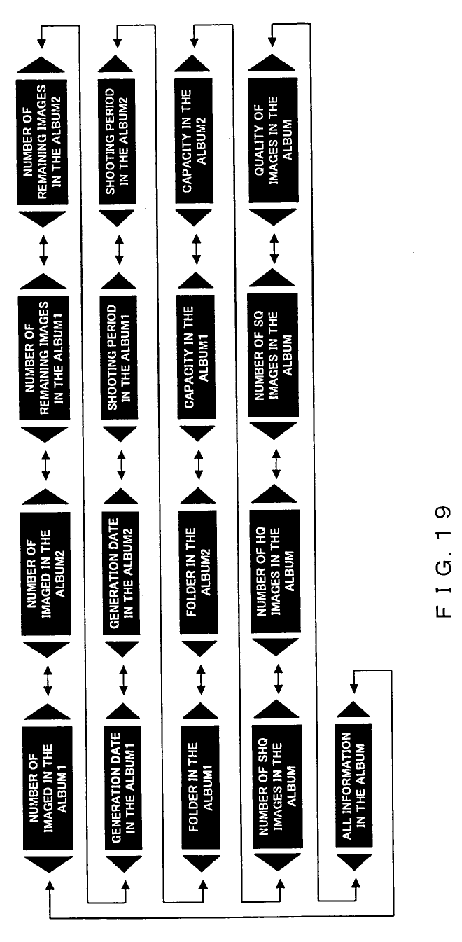

First in step S261, for example, the notation of the album information display contents display unit is switched according to the direction of the switch designation as shown in FIG. 19, and the “icon indicating the switch” is displayed in a predetermined position.

FIG. 19 shows an example of switching the contents of the display of album information.

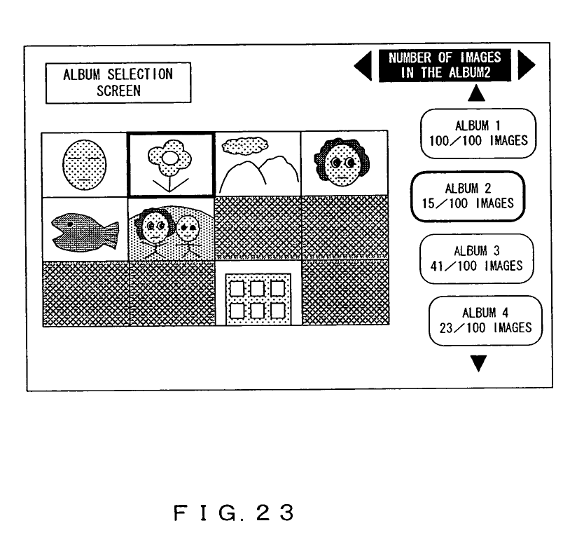

FIG. 19 shows the sequential switch of “number (1) of images in the album”, “number (2) of images in the album”, “number (1) of remaining images in the album”, “number (2) of remaining images in the album”, “generation date (1) in the album”, “generation date (2) in the album”, “shooting period (1) in the album”, “shooting period (2) in the album”, “folder (1) in the album”, “folder (2) in the album”, “capacity (1) in the album”, “capacity (2) in the album”, “number of SHQ images in the album”, “number of HQ images in the album”, “number of SQ images in the album”, “quality of images in the album”, and “all information in the album”. For example, the “number (1) of images in the album” refers to the mode of displaying album information about all albums as described later by referring to FIG. 22, and the “number (2) of images in the album” refers to the mode of displaying the album information about a part of the album as described later by referring to FIG. 23.

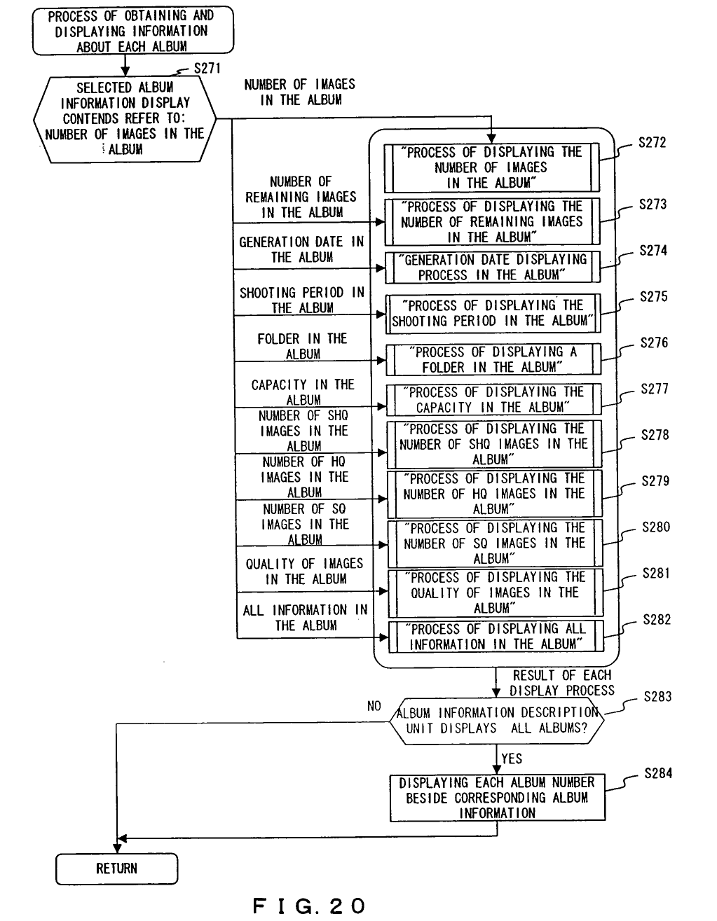

Back to the explanation by referring to FIG. 18, the “process of obtaining and displaying information about each album” described by referring to the flowchart shown in FIG. 20 is performed in step S262.

In step S263, the color of the album being selected is changed to indicate “being selected.”

Then, in step S263, the color for the album being selected is changed to indicate “being selected”.

FIG. 20 is a flowchart showing the flow of the “process of obtaining and displaying information about each album” performed in step S262 shown in FIG. 18.

First, in step S271, it is determined which refer to the contents of the display of the selected album information, the number of images in the album, the number of remaining images in the album, the generation date in the album, the shooting period in the album, the folder in the album, the capacity in the album, the number of SHQ images in the album, the number of HQ images in the album, the number of SQ images in the album, the quality of images in the album, or the all information in the album.

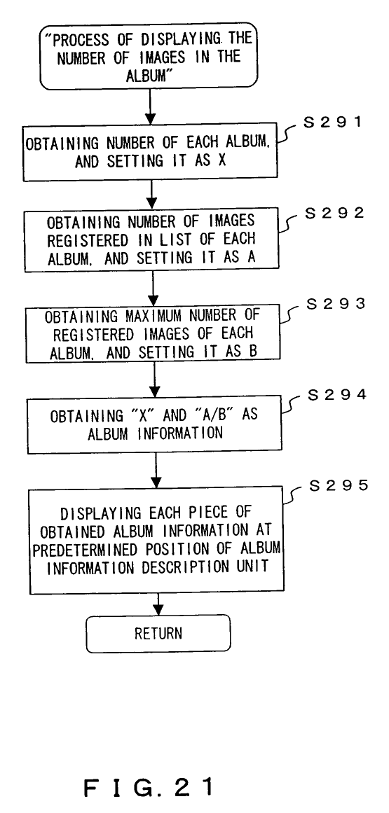

If the contents of the display of the album information selected in step S271 refer to the number of images in the album, then the “process of displaying the number of images in the album” in step S272 is performed. If they refer to the number of remaining images in the album, then the “process of displaying the number of remaining images in the album” in step S273 is performed. If they refer to the generation date in the album, then the “generation date displaying process in the album” in step S274 is performed. If they refer to the shooting period in the album, then the “process of displaying the shooting period in the album” in step S275 is performed. If they refer to the album folder, the “process of displaying a folder in the album” in step S276 is performed. If they refer to the capacity in the album, then the “process of displaying the capacity in the album” in step S277 is performed. If they refer to the number of SHQ images in the album, then the “process of displaying the number of SHQ images in the album” in step S278 is performed. If they refer to the number of HQ images in the album, then the “process of displaying the number of HQ images in the album” in step S279 is performed. If they refer to the number of SQ images in the album, then the “process of displaying the number of SQ images in the album” in step S280 is performed. If they refer to the quality of images in the album, then the “process of displaying the quality of images in the album” in step S281 is performed. If they refer to the all information in the album, then the “process of displaying all information in the album” in step S282 is performed. Each of the above-mentioned processes is described later by by referring to the flowcharts shown in FIGS. 21, 24, 27, 30, 32, 33, 34, and 36, etc.

In step S383, it is determined whether or not it is a mode of displaying the album information about all albums such as the “number (1) of images in the album”, etc.

If the determination result is YES in step S283, each album number is displayed beside the corresponding album information in step S284.

FIG. 21 is a flowchart showing the flow of the “process of displaying the number of images in the album” performed in step S272 shown in FIG. 20.

First, in step S291, the number of each album is obtained from the album list 17 (substituted for the variable X). In step S292, the number of images of each album registered in the album list 17 is obtained (substituted for the variable A). In step S293, the maximum number of registered images of each album is obtained (substituted for the variable B).

In step S294, “X” and “A/B” are obtained as album information. In step S295, the obtained album information is displayed in a predetermined position of the album information description unit.

FIG. 22 shows an example of displaying the number of registered images in a mode in which album information is displayed for all albums with a listing.

The area occupying the left two thirds of FIG. 22 is a list (indexed display) of cover images of a plurality of albums (a total of 12 albums) as shown in the illustration shown in FIG. 14B. The area occupying the right one third (album information description unit) of FIG. 22 shows the numbers (100, 15, 41, 23, etc.) indicating the number of images registered in each album (a total of 12 albums) and the numbers “15/100”, etc. with the number “100” indicating the maximum number of registered images. In the album information display contents display unit at the upper right of the figure shows the “number (1) of images in the album” indicating the mode in which album information is displayed for all albums.

FIG. 23 shows an example of display of the number of registered images in the mode in which the album information about a part of albums is displayed with a listing.

The area occupying the left two thirds of FIG. 23 shows a listing (indexed display) of cover images of a plurality of albums (a total of 12 albums) as shown in the illustration shown in FIG. 14B. The area of the right one third (album information description unit) shows the numbers (100, 15, 41, and 23) indicating the number of images registered for a part of albums (albums 1 through 4) and the number of “100” as an example of indicating the maximum number of registered images such as “15/100”. The album information display contents display unit at the upper right shows the “number (2) of images in the album” showing the mode in which the album information of a part of the album is displayed.

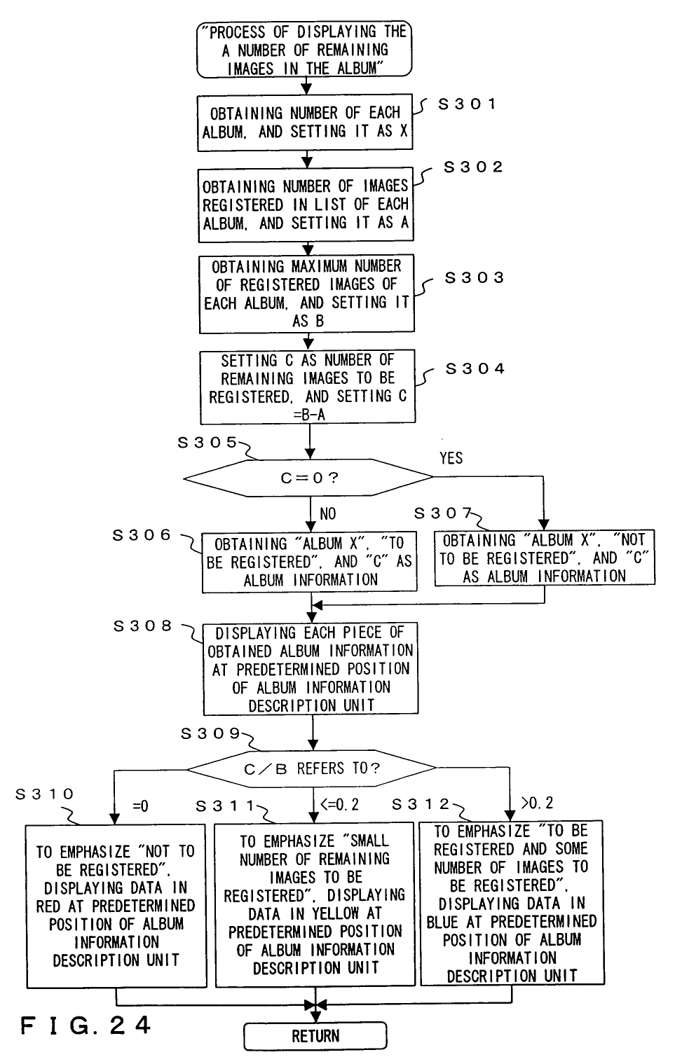

FIG. 24 is a flowchart showing the flow of the “process of displaying the number of remaining images in the album” performed in step S273 shown in FIG. 20.

First, in step S301, the number of each album is obtained from the album list 17 (substituted for the variable X). In step S302, the number of images of each album registered in the album list 17 is obtained (substituted for the variable A). In step S303, the maximum number of registered images of each album is obtained (substituted for the variable B).

In step S304, the number of remaining images to be registered indicating the number of images to be registered in the album corresponding to the selected cover images is set as a variable C, and the value (B-A) obtained by subtracting the number of images currently registered from the maximum number of registered images is substituted for the variable C.

Then, it is determined in step S304 whether or not the substituted value in step S304 is 0. If it is not 0 (the determination result is NO), then “album X”, “registration permitted”, and “C” are obtained as album information in step S306. If the value of C is 0 (the determination result is YES), then “album X”, “registration not permitted”, and “C” are obtained as album information in step S307.

In step S308, each piece of album information obtained in step S306 or S307 is displayed in a predetermined position of the album information description unit.

In step S309, it is determined whether or not the value of C/B is 0, a positive value of 0.2 or smaller, or a value larger than 0.2. That is, when C/B is 0, it indicates that the value C is 0, and the album cannot register an image any more. When it is a positive value of 0.2 or smaller, it indicates that the space in the album is 20% or less. If it is larger than 0.2, it indicates that the space of the album is 20% or larger.

If the value of C/B is 0, a predetermined position of the album information description unit is displayed in red to emphasize in step S310 that registration is not permitted. If the value of C/B is a positive value of 0.2 or smaller, the color of the predetermined position of the album information description unit is displayed in yellow to emphasize that there is a small remaining number of remaining images to be registered images in step S311. If the value of C/B is a value of 0.2 or larger, the color of the predetermined position of the album information description unit is displayed in blue in step S312 to emphasize that registration is permitted and there is still some number of remaining images to be registered.

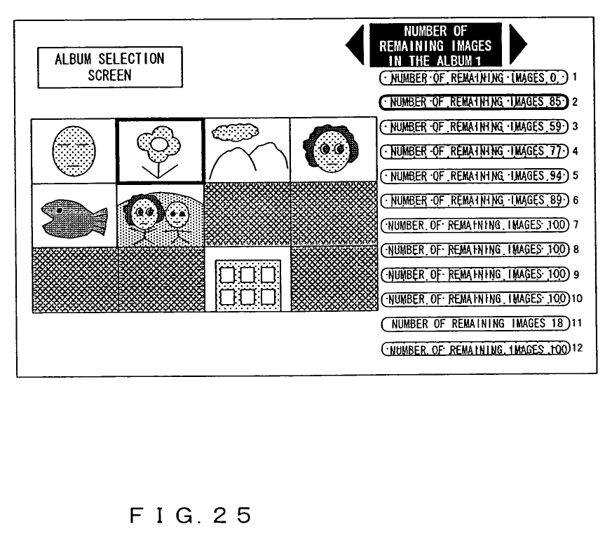

FIG. 25 shows an example of displaying the number of remaining images in a mode in which album information is displayed for all albums with a listing.

The area occupying the left two thirds of FIG. 25 is a list (indexed display) of cover images of a plurality of albums (a total of 12 albums) as shown in the illustration shown in FIG. 14B. The area occupying the right one third (album information description unit) of FIG. 25 shows the numbers indicating the number of images to be registered in each album (a total of 12 albums). In the album information display contents display unit at the upper right of the figure shows the “number (1) of remaining images in the album” indicating the mode in which album information is displayed for all albums.

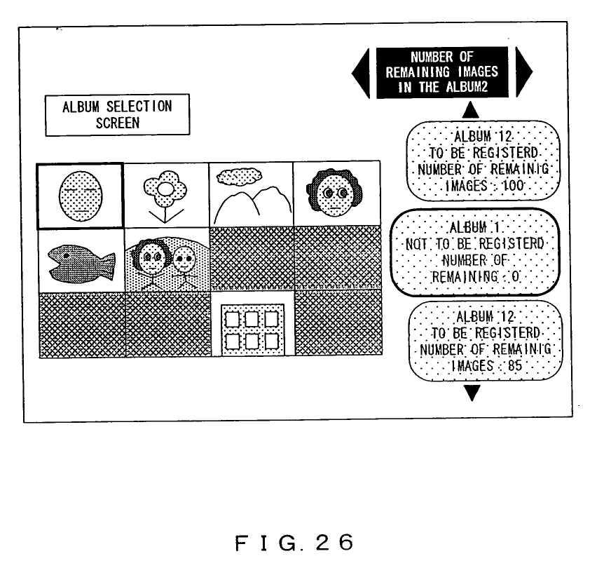

FIG. 26 shows an example of display of the number of remaining images in the mode in which the album information about a part of albums is displayed with a listing.

The area occupying the left two thirds of FIG. 26 shows a listing (indexed display) of cover images of a plurality of albums (a total of 12 albums) as shown in the illustration shown in FIG. 14B. The area of the right one third (album information description unit) shows the numbers indicating the number of images to be registered for a part of albums (albums 1 through 4). The album information display contents display unit at the upper right shows the “number (2) of remaining images in the album” showing the mode in which the album information of a part of the album is displayed.

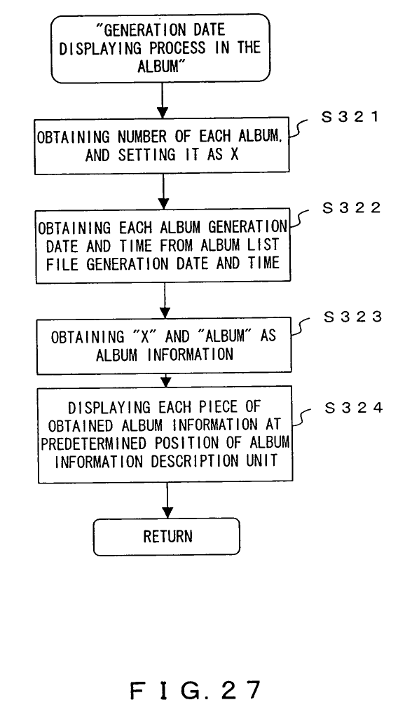

FIG. 27 is a flowchart showing the flow of the “process of displaying the number of remaining images in the album” performed in step S274 shown in FIG. 20.

First, in step S321, the number of each album is obtained from the album list 17 (substituted for the variable X). In step S322, the album generation date and time of each album registered in the album list 17 is obtained.

In step S323, “X” and “album generation date and time” are obtained as album information. In step S324, the obtained album information is displayed in a predetermined position of the album information description unit.

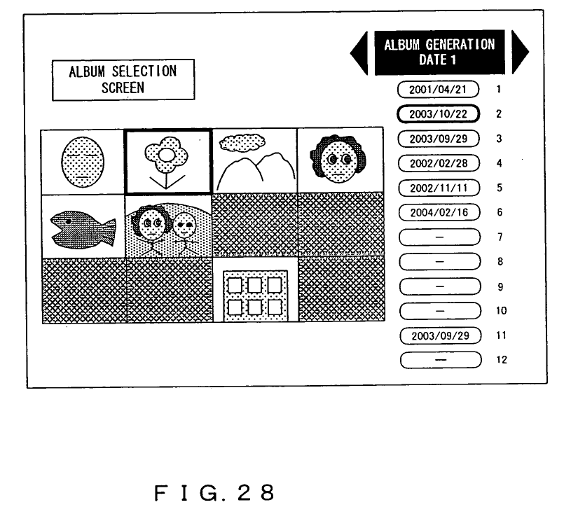

FIG. 28 shows an example of displaying the album generation date in a mode in which album information is displayed for all albums with a listing.

The area occupying the left two thirds of FIG. 28 is a list (indexed display) of cover images of a plurality of albums (a total of 12 albums) as shown in the illustration shown in FIG. 14B. The area occupying the right one third (album information description unit) of FIG. 28 shows the numbers (2001/4/21, 2003/10/22, etc.) indicating the album generation date registered in each album (a total of 12 albums). In the album information display contents display unit at the upper right of the figure shows the “album generation date 1” indicating the mode in which album information is displayed for all albums.

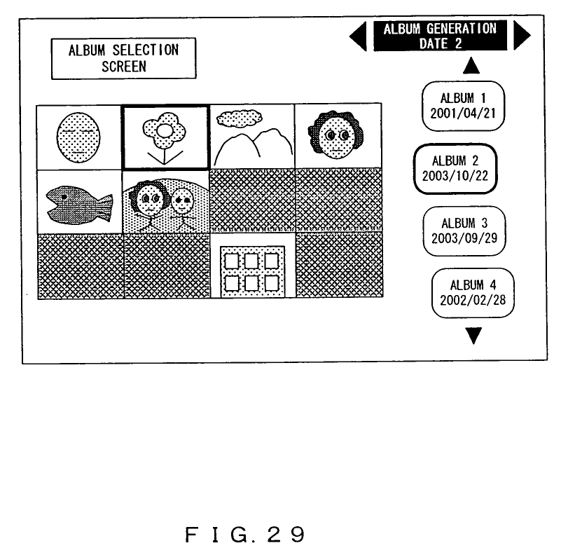

FIG. 29 shows an example of displaying the album generation date in a mode in which album information is displayed for all albums with a listing.

The area occupying the left two thirds of FIG. 29 shows a listing (indexed display) of cover images of a plurality of albums (a total of 12 albums) as shown in the illustration shown in FIG. 14B. The area of the right one third (album information description unit) shows the numbers (2001/4/21, 2003/10/22, etc.) indicating the number of registered images for a part of albums (albums 1 through 4). The album information display contents display unit at the upper right shows the “album generation date 2” showing the mode in which the album information of a part of the album is displayed.

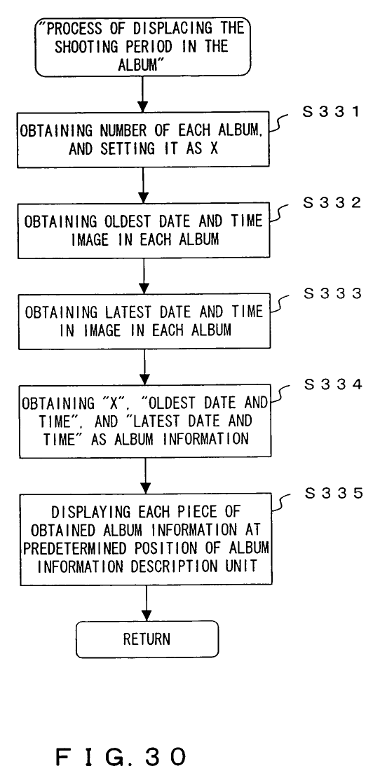

FIG. 30 is a flowchart showing the flow of the “process of displaying the shooting period in the album” performed in step S275 shown in FIG. 20.

First, in step S331, the number of each album is obtained from the album list 17 (substituted for the variable X). In step S332, the generation date and time of the oldest image in each album registered in the album list 17 is obtained. Then, in step S333, the generation date and time of the latest image in the images of each album registered in the album list 17 is obtained.

In step S334, “X”, “oldest date and time”, and “latest date and time” are obtained as album information. In step S335, each piece of the obtained album information is displayed in a predetermined position of the album information description unit. The period from the “oldest date and time” to the “latest date and time” is the shooting period of the image in the album.

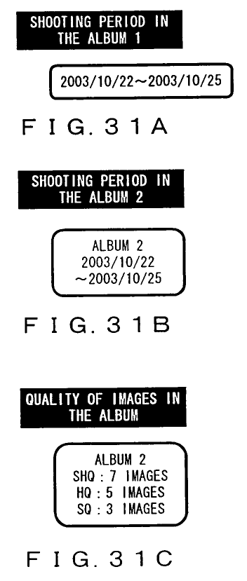

The example of displaying the shooting period in the album in the mode in which the album information is displayed for all albums together with the listing is identical to FIGS. 22, 25, and 28 except the description “2003/10/22˜2003/10/25” of the album information description unit as shown in FIG. 31A. Therefore, the identical portions are omitted. Similarly, the example of displaying the shooting period in the album in the mode in which the album information is displayed for a part of albums together with the listing is identical to FIGS. 22, 25, and 28 except the description of the album information description unit as shown in FIG. 31B. Therefore, the identical portions are omitted.

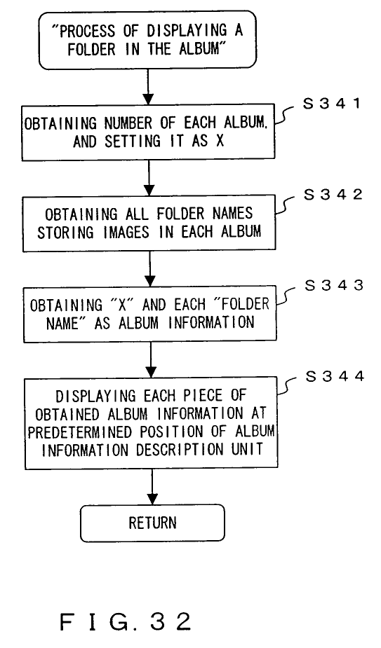

FIG. 32 is a flowchart showing the flow of the “process of displaying a folder in the album” performed in step S276 shown in FIG. 20.

First, in step S341, the number of each album is obtained from the album list 17 (substituted for the variable X). In step S342, the name of the folder storing an image of each album registered in the album list 17 is obtained.

In step S343, “X”, and each “folder name” are obtained as album information. In step S344, each piece of the obtained album information is displayed in a predetermined position of the album information description unit.

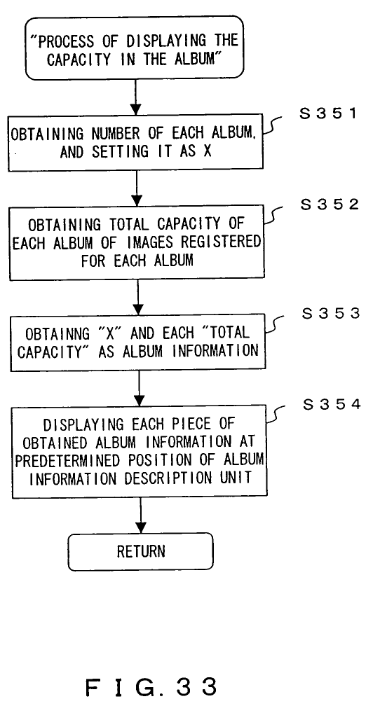

FIG. 33 is a flowchart showing the flow of the “process of displaying the capacity in the album” performed in step S277 shown in FIG. 20.

In step S351, the number of each album is obtained from the album list 17 (substituted for the variable X). In step S352, the total capacity of each album of images registered in the album list 17 is obtained.

In step S353, “X”, and each “total capacity” are obtained as album information. In step S354, each piece of the obtained album information is displayed in a predetermined position of the album information description unit.

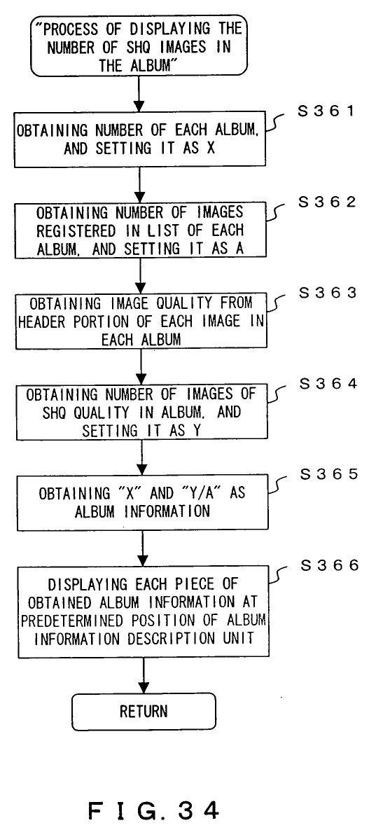

FIG. 34 is a flowchart of the flow of the “process of displaying the number of SHQ images in the album” performed in step S278 shown in FIG. 20.

In step S361, the number of each album is obtained from the album list 17 (substituted for the variable X). In step S362, the number of images of each album registered in the album list 17 is obtained (substituted for the variable A). In step S363, the quality of an image is obtained from the header portion of each image in each album.

In step S364, the number of images of SHQ quality is obtained from the album list 17 (substituted for variable Y).

In step S365, “X”, and each “Y/A” are obtained as album information. In step S366, each piece of the obtained album information is displayed in a predetermined position of the album information description unit.

The flowchart of the “process of displaying the number of HQ images in the album” performed in step S279 shown in FIG. 20 can be realized by performing the process of “obtaining the number of images of HQ quality from the album list 17” instead of the process of “obtaining the number of images of SHQ quality from the album list 17” in step S364. Therefore, the drawings of the flowchart and the detailed explanation are omitted here. Similarly, the flowchart of the “process of displaying the number of SQ images in the album” performed in step S280 shown in FIG. 20 can be realized by performing the process of “obtaining the number of images of SQ quality from the album list 17” instead of the process of “obtaining the number of images of SHQ quality from the album list 17” in step S364. Therefore, the drawings of the flowchart and the detailed explanation are omitted here.

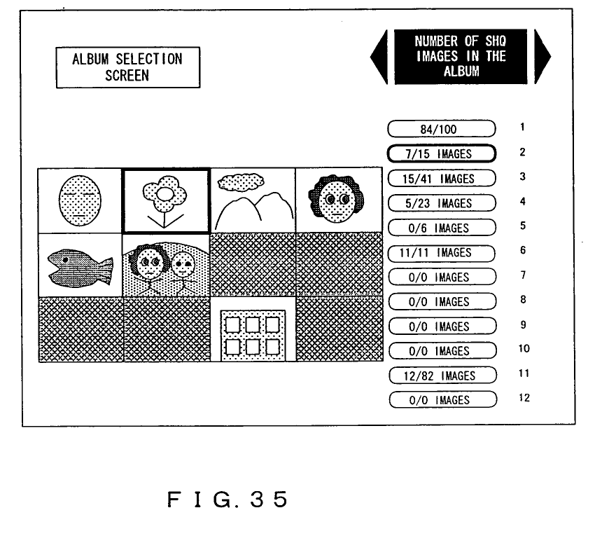

FIG. 35 shows an example of displaying the number of SHQ images in the album in the mode in which album information is displayed for all albums together with the listing.

The area occupying the left two thirds of FIG. 35 is a list (indexed display) of cover images of a plurality of albums (a total of 12 albums) as shown in the illustration shown in FIG. 14B. The area occupying the right one third (album information description unit) of FIG. 35 shows the number of SHQ (84, 7, 15, 5, etc.) in the album registered in each album (a total of 12 albums) and the numbers (100, 15, 41, 23, etc.) indicating the number of images registered for each album as “7/15”, etc. In the album information display contents display unit at the upper right of the figure shows the “number of SHQ in the album” indicating the mode in which album information is displayed for all albums.

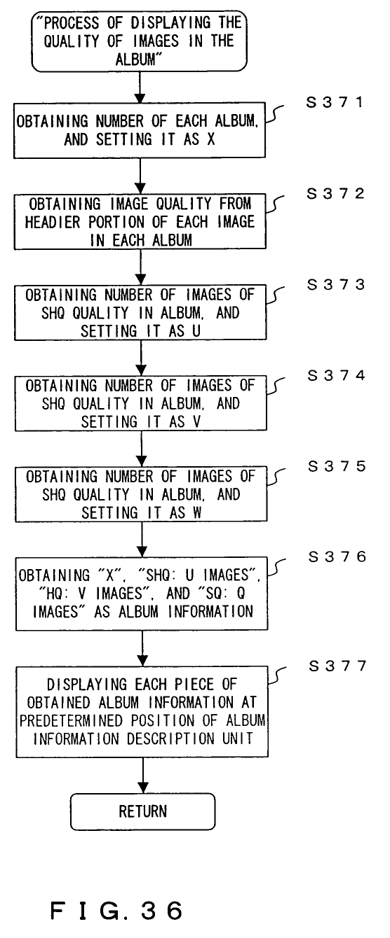

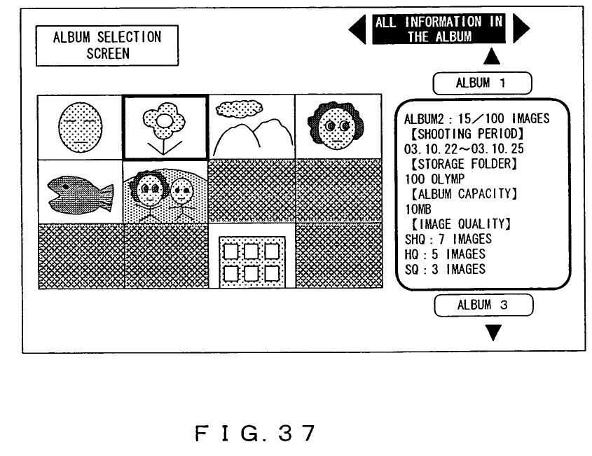

FIG. 36 is a flowchart showing the flow of the “process of displaying the quality of images in the album” performed in step S281 shown in FIG. 20.

The “process of displaying the quality of images in the album” is the process equivalent to the total of the “process of displaying the number of SHQ images in the album”, the “process of displaying the number of HQ images in the album”, and the “process of displaying the number of SQ images in the album”.

In step S371, the number of each album is obtained from the album list 17 (substituted for the variable X). In step S372, the number of images of each album registered in the album list 17 is obtained (substituted for the variable A). In step S373, the quality of an image is obtained from the header portion of each image in each album.

In step S374, the number of images of SHQ quality is obtained from the album list 17 (substituted for variable U). In step S375, the number of images of HQ quality is obtained from the album list 17 (substituted for variable V). In step S376, the number of images of SQ quality is obtained from the album list 17 (substituted for variable W).

In step S376, “X”, “SHQ:U images”, “HQ: V units”, and each “SQ: units” are obtained as album information. In step S377, each piece of the obtained album information is displayed in a predetermined position of the album information description unit. The example of display the image quality in an album is the description of the album information description unit as shown in FIG. 31C.

The “process of displaying all information in the album” performed in step S282 shown in FIG. 20 is equivalent to the total of the “process of displaying the number of images in the album” shown in FIG. 21, the “process of displaying the number of remaining images in the album” shown in FIG. 24, the “generation date displaying process in the album” shown in FIG. 27, the “process of displaying the shooting period in the album” shown in FIG. 30, the “process of displaying a folder in the album” shown in FIG. 32, the “process of displaying the capacity in the album” shown in FIG. 33, the “process of displaying the number of SHQ images in the album” shown in FIG. 34, the “process of displaying the number of HQ images in the album” not shown in the attached drawings, and the “process of displaying the number of SQ images in the album” not shown in the attached drawings. Therefore, the flowchart and the detailed explanation are omitted here.

FIG. 37 shows an example of displaying all information in the album in a mode in which album information is displayed for all albums with a listing.

The area occupying the left two thirds of FIG. 37 shows a listing (indexed display) of cover images of a plurality of albums (a total of 12 albums) as shown in the illustration shown in FIG. 14B. The area of the right one third (album information description unit) shows the numbers indicating the number of registered images for a part of albums (albums 1 through 4), the shooting period, the stored folder, etc. The album information display contents display unit at the upper right shows the “all information in an album” showing the mode in which the album information of a part of the album is displayed.

FIG. 38 shows an example of sorting and displaying album information.

The example of the display shown in FIG. 38 is an example of displaying each piece of album information (number of registered images) in an ascending order in a predetermined position of the album information description unit in the order depending on the sorting result from the state of the example of the display shown in FIG. 22 (in step S254 shown in FIG. 17).

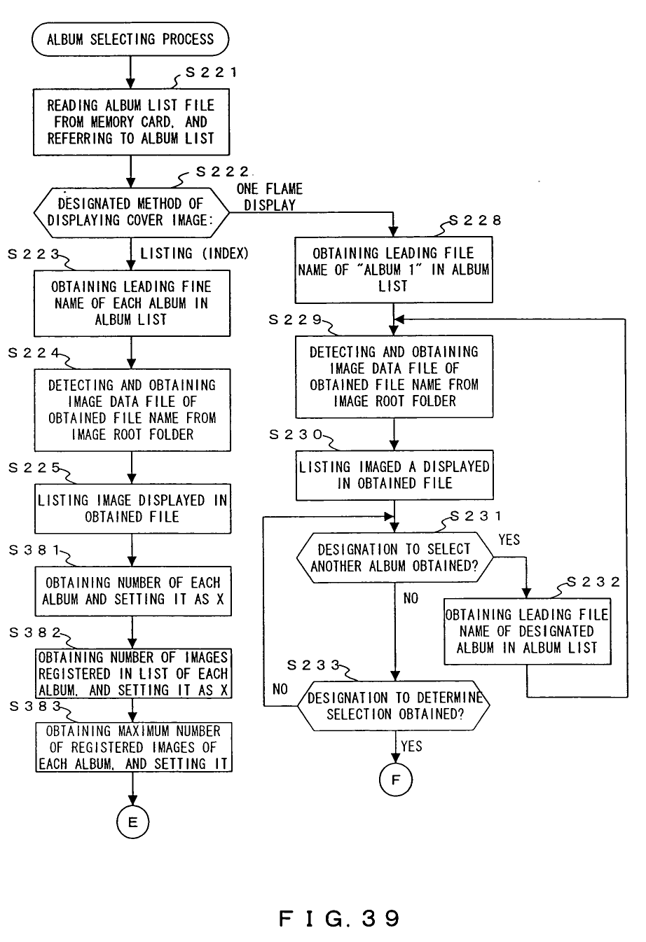

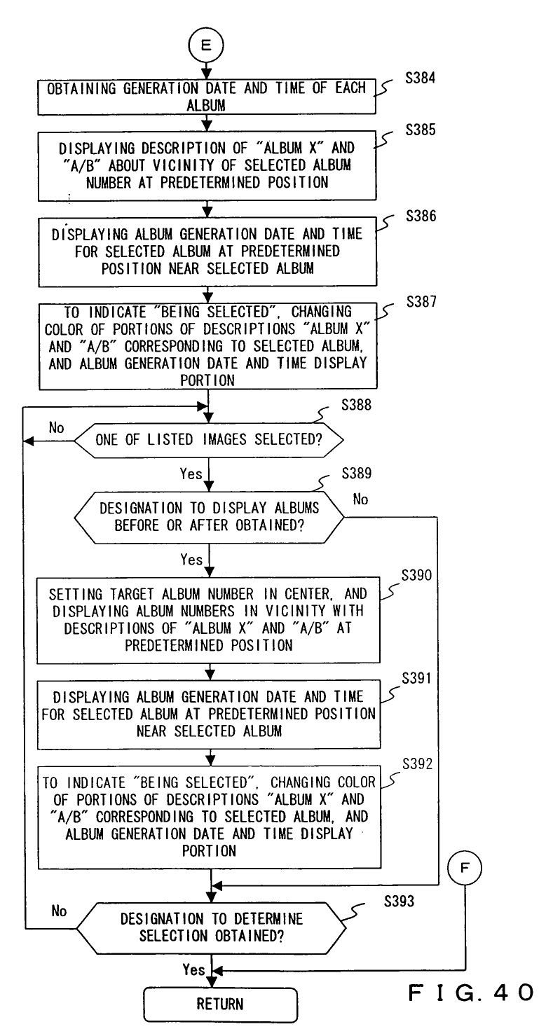

FIGS. 39 and 40 are flowcharts showing the flow of the process of displaying the number of images registered in each album and the album generation date of the selected album when the cover images of a plurality of albums are listed.

In the flowcharts shown in FIGS. 39 and 40, the processes in the steps S221 through S225 and the steps S228 through S233 are the same as those in the album regenerating process described above by referring to FIG. 15. Therefore, the detailed explanation is omitted here, and the processes in steps S381 through S394 newly added in this variation example are mainly described below.

First, in step S225 explained by referring to FIG. 15, a cover image represented by the image data file 14-n obtained in the process in the preceding step (step S224) is displayed on the display unit 28. Then, in step S381, the number of each album registered in the album list 17 (substituted for the variable X) is obtained. In step S382, the number of images of each album registered in the album list 17 is obtained (substituted for the variable A). In step S383, the maximum number of registered images which is the number of images to be registered in each album is obtained (substituted for variable B). In this example, the value of 100 is assigned as a predetermined value for all albums. That is, B=100.

Back in FIG. 40, in step S384, each album generation date and time registered in the album list 17 is obtained.

In step S385, for some albums close in album number to the selected album, the descriptions of “album X” and “A/B” are displayed in a predetermined position. In step S386, relating to the selected album, the album generation date and time is displayed in a predetermined position near the selected album.

Then, in step S387, the color of the portions of the descriptions “album X” and “A/B” and the album generation date and time display portion are changed to clearly indicate “being selected”.

In step S388, it is determined whether or not one of the listed images is selected. If the determination result is YES, it is determined in step S389 whether or not the designation to select one of the cover images listed on the display unit 28 has been issued in the operation by the user through the operation input unit 32. If there is the designation to display another album (the determination result is NO), control is passed to step S393.

If the determination result is YES in step S389, the descriptions “album X” and “A/B” on the album numbers around the selected album number in step S390, and the album generation date and time of the selected album is displayed in a position near the selected album in step S391.

Then, in step S392, the colors of the portions of the descriptions “album X” and “A/B” corresponding to the selected album, and the album generation date and time display portion are changed to clearly indicate “being selected”.

In step S393, in the operation of the user through the operation input unit 32, it is determined whether or not the designation to select one of the designated cover images has been received. If the determine designation has been issued (the determination result is YES), the album selecting process terminates. If the determine designation has not been issued (the determination result is NO), control is returned to step S388, and the above-mentioned processes are repeated.

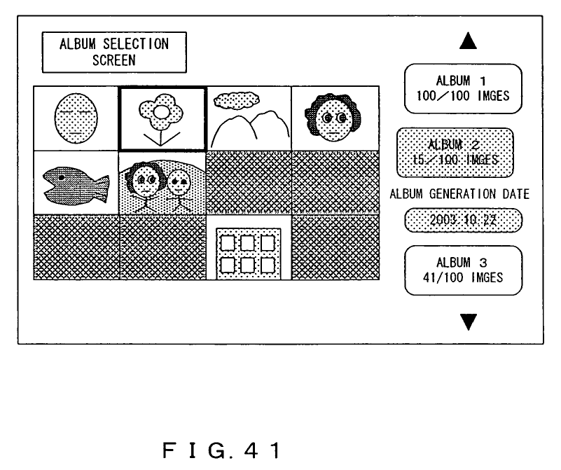

FIG. 41 shows an example of displaying the number of images registered in each album together with a listing and the album generation date of a selected album.

The area occupying the left two thirds of FIG. 41 is a list (indexed display) of cover images of a plurality of albums (a total of 12 albums) as shown in the illustration shown in FIG. 14B. The area occupying the right one third (album information description unit) of FIG. 41 shows the album numbers (albums 1 through 3) of the selected album and the albums before and after the selected album, the number (100, 15, 41, 23, etc.) indicating the number of registered images and the number “100” as an example of the maximum number of registered images as “15/100”, and the album generation date (2003.10.22) of the selected album (album 2).

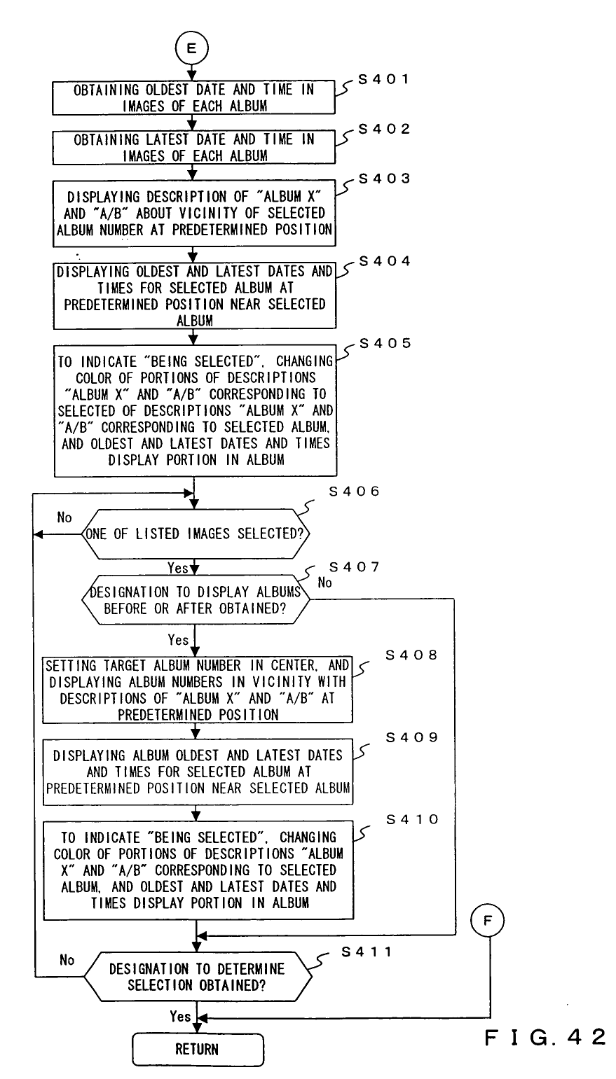

FIG. 42 is a flowchart showing the flow of the process of displaying the number of images registered in each album and the album shooting period of the selected album when the cover images of a plurality of albums are listed.

Since the steps up to step S401 are the same as the steps S221 through S225 and steps S381 through S388 shown in FIG. 39, the explanation about them is omitted.

In step S401 after step S383 (FIG. 39), the generation date and time of the oldest image in the images in each album registered in the album list 17 is obtained. In step S402, the generation date and time of the latest image in the images in each album registered in the album list 17 is obtained.

In step S403, for some albums close in album number to the selected album, the descriptions of “album X” and “A/B” are displayed in a predetermined position. In step S404, relating to the selected album, the period from the “oldest date and time” to the “latest date and time” is displayed as the shooting period of the image in the album in a predetermined position near the selected album.

Then, in step S405, the color of the portions of the descriptions “album X” and “A/B” and the album generation date and time display portion are changed to clearly indicate “being selected”.

In step S406, it is determined whether or not one of the listed images is selected. If the determination result is YES, it is determined in step S407 whether or not the designation to select one of the cover images listed on the display unit 28 has been issued in the operation by the user through the operation input unit 32. If there is the designation to display another album (the determination result is NO), control is passed to step S411.

If the determination result is YES in step S407, the descriptions “album X” and “A/B” on the album numbers around the selected album number in step S408, and the period from the “oldest date and time” to the “latest date and time” is displayed as the shooting period of the image in the album in a position near the selected album in step S409.

Then, in step S410, the colors of the portions of the descriptions “album X” and “A/B” corresponding to the selected album, and the album generation date and time display portion are changed to clearly indicate “being selected”.

In step S411, in the operation of the user through the operation input unit 32, it is determined whether or not the designation to select one of the designated cover images has been received. If the determine designation has been issued (the determination result is YES), the album selecting process terminates. If the determine designation has not been issued (the determination result is NO), control is returned to step S406, and the above-mentioned processes are repeated.

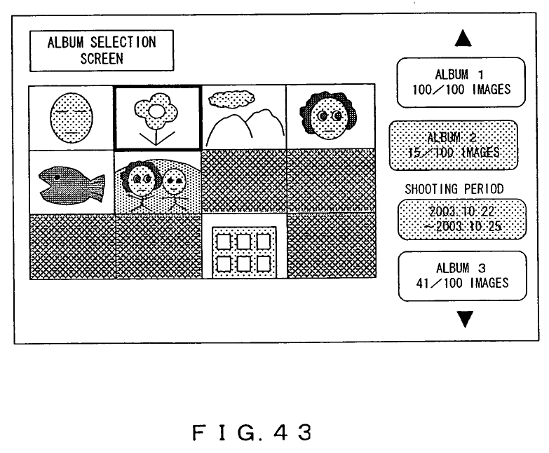

FIG. 43 shows an example of displaying the number of images registered in each album together with a listing and the album generation date of a selected album.

The area occupying the left two thirds of FIG. 43 is a list (indexed display) of cover images of a plurality of albums (a total of 12 albums) as shown in the illustration shown in FIG. 14B. The area occupying the right one third (album information description unit) of FIG. 43 shows the album numbers (albums 1 through 3) of the selected album and the albums before and after the selected album, the number (100, 15, 41, 23, etc.) indicating the number of registered images and the number “100” as an example of the maximum number of registered images as “115/100”, and the album shooting period (2003.10.22˜2003.10.25) of the selected album (album 2).

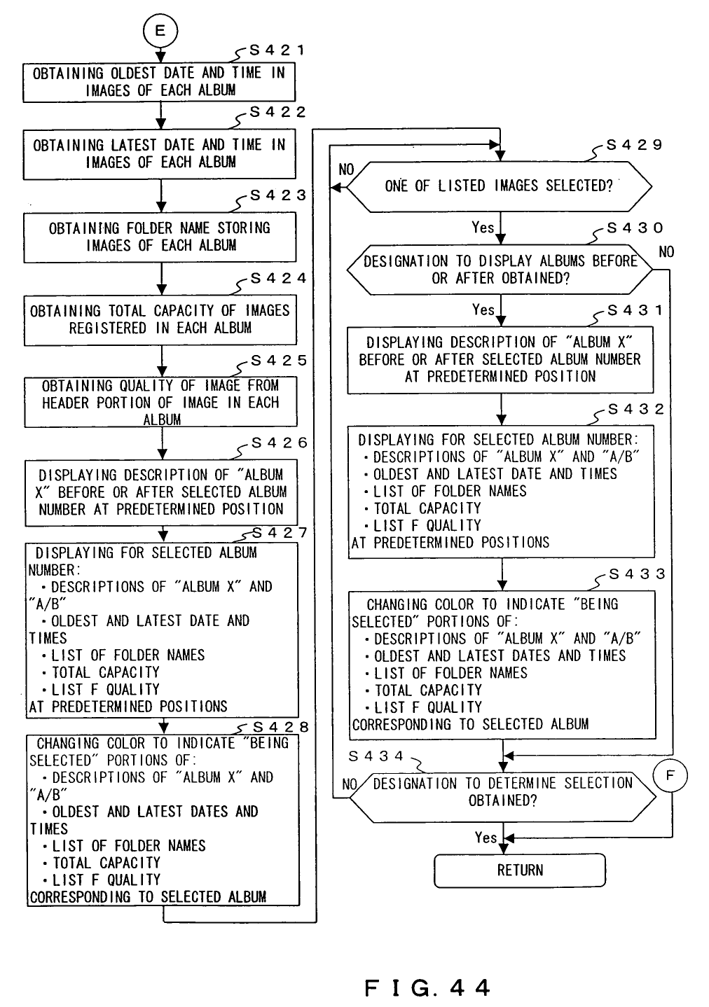

FIG. 44 is a flowchart showing the flow of the process of displaying the album information about a selected album when the cover images of a plurality of albums are listed.

Since the steps up to step S421 are the same as the steps S221 through S225 and steps S381 through S388 shown in FIG. 39, the explanation about them is omitted.

After step S383 (FIG. 39), the generation date and time of the oldest image in the images in each album registered in the album list 17 is obtained (step S421), the generation date and time of the latest image in the images of each album is obtained (step S422), all names of folders storing the images in each album are obtained (step S423), the total capacity of each album of registered images is obtained (step S424), and the image quality is obtained from the header portion of each image in each album (step S425).

In step S426, for some albums close in album number to the selected album, the description of “album X” is displayed in a predetermined position. In step S427, relating to the selected album, the descriptions of “album X” and “A/B”, the oldest date and time and the latest date and time, a list of folder names, the total capacity, and a list of quality are displayed in a predetermined position near the selected album.

Then, in step S428, the colors of the descriptions of “album X” and “A/B”, the oldest date and time and the latest date and time, a list of folder names, the total capacity, and a list of quality corresponding to the selected album are changed to clearly indicate “being selected”.

In step S429, it is determined whether or not one of the listed images is selected. If the determination result is YES, it is determined in step S430 whether or not the designation to select one of the cover images listed on the display unit 28 has been issued in the operation by the user through the operation input unit 32. If there is the designation to display another album (the determination result is NO), control is passed to step S434.

If the determination result is YES in step S430, the description “album X” on the album numbers around the selected album number in step S431, and the descriptions of “album X” and “A/B”, the oldest date and time and the latest date and time, a list of folder names, the total capacity, and a list of quality are displayed in a position near the selected album in step S432.

Then, in step S433, the colors of the portions of “album X” and “A/B”, the oldest date and time and the latest date and time, a list of folder names, the total capacity, and a list of quality corresponding to the selected album are changed to clearly indicate “being selected”.

In step S434, in the operation of the user through the operation input unit 32, it is determined whether or not the designation to select one of the designated cover images has been received. If the determine designation has been issued (the determination result is YES), the album selecting process terminates. If the determine designation has not been issued (the determination result is NO), control is returned to step S429, and the above-mentioned processes are repeated.

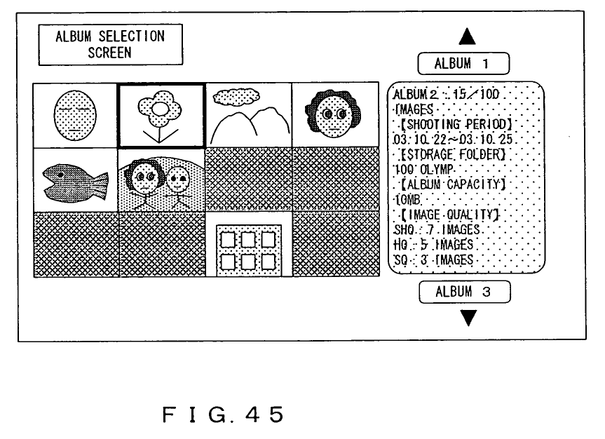

FIG. 45 shows an example of displaying the listing and the album information about the album.

The area occupying the left two thirds of FIG. 45 is a list (indexed display) of cover images of a plurality of albums (a total of 12 albums) as shown in the illustration shown in FIG. 14B. The area occupying the right one third (album information description unit) of FIG. 43 shows the album numbers (albums 1 through 3) of the selected album and the albums before and after the selected album, and the descriptions of “album X” and “A/B”, the oldest date and time and the latest date and time, a list of folder names, the total capacity, and a list of quality corresponding to the selected album (album 2) are displayed.

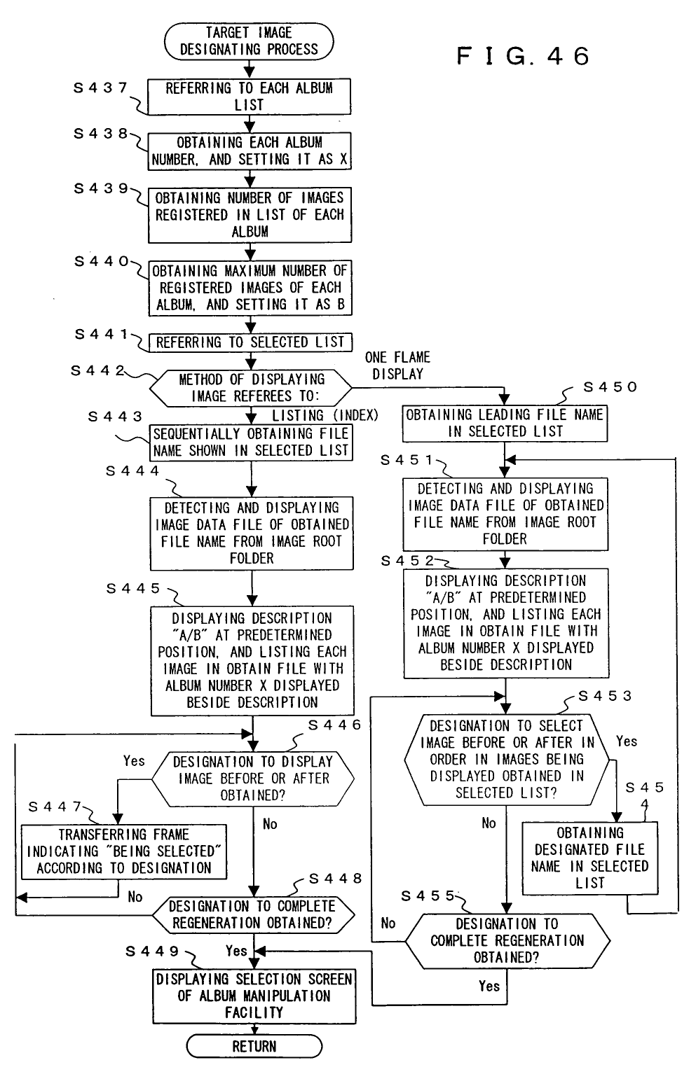

FIG. 46 is a flowchart showing the flow of the process of displaying the number of images registered in all albums when images registered in a specific album are displayed.

First, in step S437, the process of referring to the album list 17 of each album is performed.

In step S438, the number of each album registered in the album list 17 (substituted for the variable X) is obtained. In step S439, the number of images of each album registered in the album list 17 is obtained (substituted for the variable A). In step S440, the maximum number of registered images which is the number of images to be registered in each album is obtained (substituted for variable B). In this example, the value of 100 is assigned as a predetermined value for all albums. That is, B=100.

In step S441, the list of selected albums is referred to.

In step S442, it is determined what are the contents of the designation about the method of displaying an image on the display unit 28 performed by a user through the operation input unit 32. If the contents of the designation refer to the listing (indexed display) of a plurality of images, then control is passed to step S443.

In step S443, the file names in the selected list are sequentially obtained. In step S444, the image data file 14-n which is the obtained file name is retrieved from the image root folder 12 of the memory card 11.

In step S445, an image represented in an obtained fine with the description “A/B” in a predetermined position with the album number X added beside it.

In step S446, it is determined whether or not the designation to display images before and after a specific image. If the determination result is YES, the frame indicating “being selected” is transferred at the designation in step S447, and then control is returned to step S446. If the determination result in step S446 is NO, then it is determined in step S448 whether or not the designation to terminate the registration has been obtained. If the determine designation has been issued (the determination result is YES), the target image designating process is terminated. If the determine designation has not been issued (the determination result is NO), then control is returned to step S446, and the above-mentioned processes are repeated.

If the contents of the designation refer to the display images frame by frame (onr-frame display), then the leading file name in the listed file names is obtained in step S450.

In step S451, the image data file 14-n which is a file name obtained in the process performed immediately before is retrieved and obtained from the image root folder 12 on the memory card 11.

In step S452, an image represented in an obtained fine with the description “A/B” in a predetermined position with the album number X added beside it.

In step S453, it is determined whether or not the designation to select an image of the file name which is before or after the file name of the image data file representing the image being displayed on the display unit 18 in the above-mentioned selected list has been obtained in the operation of a user through the operation input unit 32. If the designation has been obtained (the determination result is YES), the file name of the designated order in the selected list is obtained in step S454. Afterwards, control is returned to step S451, and the above-mentioned processes are repeated.

If the designation has not been obtained in step S453 (the determination result is NO), then it is determined whether or not the designation to select an image being displayed on the display unit 18 has been obtained in the operation by a user through the operation input unit 32. When the determine designation is issued (the determination result is YES), control is passed to step S449. If the determine designation has not been issued (the determination result is NO), then control is returned to step S453, and the above-mentioned processes are repeated.

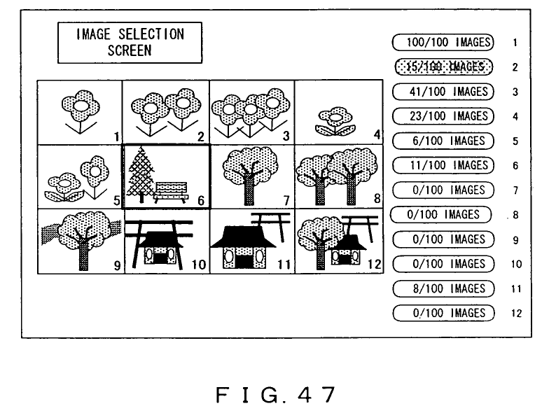

FIG. 47 shows an example of displaying the number of images registered in all albums together with the listing of the images registered in a specific album.

The area occupying the left two thirds of FIG. 47 is a list (indexed display) of images registered in a selected album. The area occupying the right one third (album information description unit) of FIG. 43 shows the number (100, 15, 41, 23, etc.) indicating the number of registered images of each album (a total of 12 albums) including selected albums and the number “100” as an example of the maximum number of registered images as “15/100”.

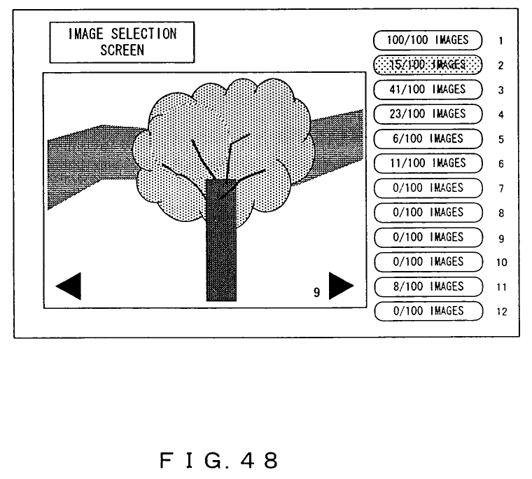

FIG. 48 shows an example of displaying the number of images registered in all albums together with one of the images registered in a specific album.

The area occupying the left two thirds of FIG. 48 is one of the images registered in a selected album in one frame. The area occupying the right one third (album information description unit) of FIG. 43 shows the number (100, 15, 41, 23, etc.) indicating the number of registered images of each album (a total of 12 albums) including selected albums and the number “100” as an example of the maximum number of registered images as “15/100”.

Described above are the embodiments of the present invention, but the digital camera, the album managing method, the album management program product, and the album management program transmission medium to which the present invention is applied are not limited to the above-mentioned embodiments, and there can be variations in various configurations and shapes within the gist of the present invention.

1. A digital camera having a control file for managing a taken image, an album facility for generating and managing an album configured by one or more images based on the control file, and a display device for displaying an image, comprising:
a device obtaining the number of registered images of the album for obtaining the number of registered images of the album which is the number of images configuring the album based on the control file; and
a device obtaining the number of remaining images to be registered in the album for obtaining the number of remaining images to be registered in the album which is the number of remaining images to be taken and registered in the album based on the maximum number of registered images capable of configuring the album which is predetermined, wherein
the display device displays an arbitrary image configuring part of the album, and switches and displays the number of registered images of the album obtained by the device for obtaining the number of registered images of the album or the number of remaining images to be registered in the album obtained by the device for obtaining the number of remaining images to be registered in the album.

2. The digital camera according to claim 1, wherein:
the device for obtaining the number of registered images of the album obtains the number of registered images of an album for a plurality of albums;
the device for obtaining the number of remaining images to be registered in the album obtains the number of remaining images to be registered in an album for a plurality of albums; and
the display device displays the registered images of a selected album or the number of remaining images to be registered in the album, and displays the registered images of an unselected album or the number of remaining images to be registered in the album in different formats.

3. The digital camera according to claim 2, further comprising
a shooting date obtaining device obtaining the shooting date of an arbitrary image configuring the album based on the control file, wherein
the display device switches and displays the number of registered images of the album, the number of remaining images to be registered in the album, or the shooting periods of all images configuring the album obtained based on the shooting dates of all images configuring the album obtained by the shooting date obtaining device.

4. The digital camera according to claim 3, wherein
the display device switches and displays the number of registered images of the album, the number of remaining images to be registered in the album, the shooting period, or an album generation date indicating the day on which the album obtained based on the control file was generated.

5. The digital camera according to claim 4, further comprising
based on the control file an image information obtaining device obtaining the image capacity indicating the capacity of all images configuring the album, the image quality indicating the quality of an image configuring the album, and the image type information about the type of the image configuring part of the album, wherein
the display device switches and displays the number of registered images of the album, the number of remaining images to be registered in the album, the shooting period, or the album generation date, and the image capacity, the image quality, or the image type information obtained by the image information obtaining device.

6. The digital camera according to claim 2, wherein
the display device displays the number of registered images of a selected album, the number of remaining images to be registered in the album, the shooting period, the album generation date, the image capacity, and the image quality, or displays together with the display of the image type information the number of registered images of an album near the selected album among unselected albums, the number of remaining images to be registered in the album, the shooting period, the album generation date, the image capacity, the image quality, or the image type information.

7. The digital camera according to claim 2, wherein
the display device displays the number of registered images of the album, the number of remaining images to be registered in the album, the shooting period, the album generation date, the image capacity, the image quality, or the image type information in an ascending or descending order.

8. A digital camera having a control file for managing a taken image, an album facility for generating and managing an album configured by one or more images based on the control file, and a display device for displaying an image, comprising:
a device obtaining the number of registered images of the album for obtaining the number of registered images of the album which is the number of images configuring the album based on the control file; and
a device obtaining the number of remaining images to be registered in the album for obtaining the number of remaining images to be registered in the album which is the number of remaining images to be taken and registered in the album based on the maximum number of registered images capable of configuring the album which is predetermined, wherein
the display device displays an arbitrary image configuring part of the album, displays the number of registered images of the album obtained by the device for obtaining the number of registered images of the album, and displays the number of remaining images to be registered in the album obtained by the device for obtaining the number of remaining images to be registered in the album for a selected album.

9. The digital camera according to claim 8, wherein
the display device displays the registered images of a selected album and the number of remaining images to be registered in the album in a format different from the registered images of unselected albums.

10. An album managing method used by a digital camera having a control file for managing a taken image, an album facility for generating and managing an album configured by one or more images based on the control file, and a display device for displaying an image, comprising:
obtaining the number of registered images of the album for obtaining the number of registered images of the album which is the number of images configuring the album based on the control file;
obtaining the number of remaining images to be registered in the album for obtaining the number of remaining images to be registered in the album which is the number of remaining images to be taken and registered in the album based on the maximum number of registered images capable of configuring the album which is predetermined;
display by the display device displaying an arbitrary image configuring part of the album, and switching and displaying the number of registered images of the obtained album or the number of remaining images to be registered in the obtained album.

11. The method according to claim 10, wherein:
obtaining the number of registered images of the album obtains the number of registered images of an album for a plurality of albums;
obtaining the number of remaining images to be registered in the album obtains the number of remaining images to be registered in an album for a plurality of albums;
display by the display device displays the registered images of a selected album or the number of remaining images to be registered in the album, and displays the registered images of an unselected album or the number of remaining images to be registered in the album in different formats.

12. The method according to claim 11, further comprising
obtaining the shooting date of an arbitrary image configuring the album based on the control file, wherein
display by the display device switching and displaying the number of registered images of the album, the number of remaining images to be registered in the album, or the shooting periods of all images configuring the album obtained based on the shooting dates of all images configuring the album obtained by the shooting date obtaining device.

13. The method according to claim 12, wherein
the display by the display device switches and displays the number of registered images of the album, the number of remaining images to be registered in the album, the shooting period, or an album generation date indicating the day on which the album obtained based on the control file was generated.

14. The method according to claim 13, wherein
based on the control file, the image capacity indicating the capacity of all images configuring the album, the image quality indicating the quality of an image configuring the album, and the image type information about the type of the image configuring part of the album are obtained; and display by the display device switches and displays the number of registered images of the album, the number of remaining images to be registered in the album, the shooting period, or the album generation date, and the obtained image capacity, the image quality, or the image type information.

15. The method according to claim 11, wherein
display by the display device displays the number of registered images of a selected album, the number of remaining images to be registered in the album, the shooting period, the album generation date, the image capacity, and the image quality, or displays together with the display of the image type information the number of registered images of an album near the selected album among unselected albums, the number of remaining images to be registered in the album, the shooting period, the album generation date, the image capacity, the image quality, or the image type information.

16. The method according to claim 11, wherein
display by the display device displays the number of registered images of the album, the number of remaining images to be registered in the album, the shooting period, the album generation date, the image capacity, the image quality, or the image type information in an ascending or descending order.

17. An album managing method used by a digital camera having a control file for managing a taken image, an album facility for generating and managing an album configured by one or more images based on the control file, and a display device for displaying an image, comprising:
obtaining the number of registered images of the album for obtaining the number of registered images of the album which is the number of images configuring the album based on the control file;
obtaining the number of remaining images to be registered in the album for obtaining the number of remaining images to be registered in the album which is the number of remaining images to be taken and registered in the album based on the maximum number of registered images capable of configuring the album which is predetermined; and
display by the display device displaying an arbitrary image configuring part of the album, displaying the number of registered images of the obtained album and the number of remaining images to be registered in the obtained album for a selected album.

18. The method according to claim 17, wherein
display by the display device displays the registered images of a selected album and the number of remaining images to be registered in the album in a format different from the registered images of unselected albums.

19. An album management program product used to direct a digital camera having a control file for managing a taken image, an album facility for generating and managing an album configured by one or more images based on the control file, and a display device for displaying an image to perform the procedures of:
obtaining the number of registered images of the album for obtaining the number of registered images of the album which is the number of images configuring the album based on the control file;
obtaining the number of remaining images to be registered in the album for obtaining the number of remaining images to be registered in the album which is the number of remaining images to be taken and registered in the album based on the maximum number of registered images capable of configuring the album which is predetermined;
display by the display device displaying an arbitrary image configuring part of the album, and switching and displaying the number of registered images of the obtained album or the number of remaining images to be registered in the obtained album.

20. The product according to claim 19, wherein:
the procedure of obtaining the number of registered images of the album obtains the number of registered images of an album for a plurality of albums;
the procedure of obtaining the number of remaining images to be registered in the album obtains the number of remaining images to be registered in an album for a plurality of albums; and
the procedure of the display by the display device displays the registered images of a selected album or the number of remaining images to be registered in the album, and displays the registered images of an unselected album or the number of remaining images to be registered in the album in different formats.

21. The product according to claim 20, further comprising
the procedure of obtaining the shooting date of an arbitrary image configuring the album based on the control file, wherein
the procedure of the display by the display device switching and displaying the number of registered images of the album, the number of remaining images to be registered in the album, or the shooting periods of all images configuring the album obtained based on the shooting dates of all images configuring the album obtained by the shooting date obtaining device.

22. The product according to claim 21, wherein
the procedure of the display by the display device switches and displays the number of registered images of the album, the number of remaining images to be registered in the album, the shooting period, or an album generation date indicating the day on which the album obtained based on the control file was generated.

23. The product according to claim 22, further comprising
the procedure of obtaining based on the control file the image capacity indicating the capacity of all images configuring the album, the image quality indicating the quality of an image configuring the album, and the image type information about the type of the image configuring part of the album, wherein
the procedure of the display by the display device switches and displays the number of registered images of the album, the number of remaining images to be registered in the album, the shooting period, or the album generation date, and the obtained image capacity, the image quality, or the image type information.

24. The product according to claim 20, wherein
the procedure of the display by the display device displays the number of registered images of a selected album, the number of remaining images to be registered in the album, the shooting period, the album generation date, the image capacity, and the image quality, or displays together with the display of the image type information the number of registered images of an album near the selected album among unselected albums, the number of remaining images to be registered in the album, the shooting period, the album generation date, the image capacity, the image quality, or the image type information.

25. The product according to claim 20, wherein
the procedure of the display by the display device displays the number of registered images of the album, the number of remaining images to be registered in the album, the shooting period, the album generation date, the image capacity, the image quality, or the image type information in an ascending or descending order.

26. An album management program product used to direct a digital camera having a control file for managing a taken image, an album facility for generating and managing an album configured by one or more images based on the control file, and a display device for displaying an image to perform the procedures of:
obtaining the number of registered images of the album for obtaining the number of registered images of the album which is the number of images configuring the album based on the control file;
obtaining the number of remaining images to be registered in the album for obtaining the number of remaining images to be registered in the album which is the number of remaining images to be taken and registered in the album based on the maximum number of registered images capable of configuring the album which is predetermined; and
display by the display device displaying an arbitrary image configuring part of the album, displaying the number of registered images of the obtained album and the number of remaining images to be registered in the obtained album for a selected album.

27. The product according to claim 26, wherein
the procedure of the display by the display device displays the registered images of a selected album and the number of remaining images to be registered in the album in a format different from the registered images of unselected albums.

28. An album management program transmission medium used to direct a digital camera having a control file for managing a taken image, an album facility for generating and managing an album configured by one or more images based on the control file, and a display device for displaying an image to perform the procedures of:
obtaining the number of registered images of the album for obtaining the number of registered images of the album which is the number of images configuring the album based on the control file;
obtaining the number of remaining images to be registered in the album for obtaining the number of remaining images to be registered in the album which is the number of remaining images to be taken and registered in the album based on the maximum number of registered images capable of configuring the album which is predetermined; and
display by the display device displaying an arbitrary image configuring part of the album, and switching and displaying the number of registered images of the obtained album or the number of remaining images to be registered in the obtained album.

29. The medium according to claim 28, wherein:
the procedure of obtaining the number of registered images of the album obtains the number of registered images of an album for a plurality of albums;
the procedure of obtaining the number of remaining images to be registered in the album obtains the number of remaining images to be registered in an album for a plurality of albums; and
the procedure of the display by the display device displays the registered images of a selected album or the number of remaining images to be registered in the album, and displays the registered images of an unselected album or the number of remaining images to be registered in the album in different formats.

30. The medium according to claim 29, further comprising
the procedure of obtaining the shooting date of an arbitrary image configuring the album based on the control file, wherein
the procedure of the display by the display device switching and displaying the number of registered images of the album, the number of remaining images to be registered in the album, or the shooting periods of all images configuring the album obtained based on the shooting dates of all images configuring the album obtained by the shooting date obtaining device.

31. The medium according to claim 30, wherein
the procedure of the display by the display device switches and displays the number of registered images of the album, the number of remaining images to be registered in the album, the shooting period, or an album generation date indicating the day on which the album obtained based on the control file was generated.

32. The medium according to claim 31, further comprising
the procedure of obtaining based on the control file the image capacity indicating the capacity of all images configuring the album, the image quality indicating the quality of an image configuring the album, and the image type information about the type of the image configuring part of the album, wherein
the procedure of the display by the display device switches and displays the number of registered images of the album, the number of remaining images to be registered in the album, the shooting period, or the album generation date, and the obtained image capacity, the image quality, or the image type information.

33. The medium according to claim 29, wherein
the procedure of the display by the display device displays the number of registered images of a selected album, the number of remaining images to be registered in the album, the shooting period, the album generation date, the image capacity, and the image quality, or displays together with the display of the image type information the number of registered images of an album near the selected album among unselected albums, the number of remaining images to be registered in the album, the shooting period, the album generation date, the image capacity, the image quality, or the image type information.

34. The medium according to claim 29, wherein
the procedure of the display by the display device displays the number of registered images of the album, the number of remaining images to be registered in the album, the shooting period, the album generation date, the image capacity, the image quality, or the image type information in an ascending or descending order.

35. An album management program transmission medium used to direct a digital camera having a control file for managing a taken image, an album facility for generating and managing an album configured by one or more images based on the control file, and a display device for displaying an image to perform the procedures of:
obtaining the number of registered images of the album for obtaining the number of registered images of the album which is the number of images configuring the album based on the control file;
obtaining the number of remaining images to be registered in the album for obtaining the number of remaining images to be registered in the album which is the number of remaining images to be taken and registered in the album based on the maximum number of registered images capable of configuring the album which is predetermined;
display by the display device displaying an arbitrary image configuring part of the album, and displaying the number of registered images of the obtained album and the number of remaining images to be registered in the obtained album for a selected album.

36. The medium according to claim 35, wherein
the procedure of the display by the display device displays the registered images of a selected album and the number of remaining images to be registered in the album in a format different from the registered images of unselected albums.
